(19) United States
(12) Patent Application Publication
(10) Pub. No.: US 2023/0160718 A1
(43) Pub. Date: May 25, 2023

(54) CENTRAL APPARATUS, MAP GENERATION SYSTEM, AND MAP GENERATION METHOD

(71) Applicant: Mitsubishi Electric Corporation, Tokyo (JP)

(72) Inventors: Yoshiaki ADACHI, Tokyo (JP); Kentaro DAIKOKU, Tokyo (JP); Yuji IGARASHI, Tokyo (JP)

(73) Assignee: Mitsubishi Electric Corporation, Tokyo (JP)

(21) Appl. No.: 17/921,647

(22) PCT Filed: Jul. 14, 2020
(86) PCT No.: PCT/JP2020/027304

§ 371 Date: Oct. 27, 2022

(51) Int. Cl. G01C 21/00; G01C 21/32

(52) U.S. Cl. CPC G01C 21/3844; G01C 21/3896; G01C 21/3815; G01C 21/32

(57) ABSTRACT

A technique is provided with which it is possible to appropriately reduce communication data volume. A central apparatus communicates with a mobile terminal that is movable with a mobile body. The mobile terminal includes extraction-information generation means that generates extraction information by extraction from measurement information. The central apparatus includes map-information generation means that generates map information based on the extraction information transmitted from the mobile terminal to the central apparatus, and map generation control means that evaluates completeness of the map information generated by the map-information generation means and generates command information based on the completeness.

### TECHNICAL FIELD

The present disclosure relates to a central apparatus, a map generation system, and a map generation method.

### BACKGROUND ART

The map generation system generates map information with submeter positional accuracy by measuring a space to be mapped with a space measuring sensor and estimating positional information and shape information on features based on the result of measurements. Such a map generation system may be configured by, for example, one or more mobile terminals that measure a space to be mapped, and a central apparatus that generates map information based on the result of measurements performed by the mobile terminals.

In this map generation system, the result of measurements is transmitted from the mobile terminals to the central apparatus by wireless communication. Since the result of measurements is large in data volume, it is necessary to reduce data volume associated with communication. For example, the map generation system described in Patent Document 1 reduces communication data volume by causing the mobile terminals to extract necessary information from the result of measurements based on a predetermined feature quantity.

### PRIOR ART DOCUMENT

### Patent Documents

Patent Document 1: Japanese Patent Application Laid-Open No. 2014-228637

### SUMMARY

### Problem to be Solved by the Invention

There is, however, a problem with the map generation system according to Patent Document 1 in that it has not been possible to appropriately reduce communication data volume because in some cases the mobile terminals may also transmit unnecessary information to the central apparatus.

The present disclosure has been made in light of problems as described above, and it is an object of the present disclosure to provide a technique with which it is possible to appropriately reduce communication data volume.

### Means to Solve the Problem

A central apparatus according to the present disclosure includes is a central apparatus for communicating with a mobile terminal that is movable with a mobile body. The mobile terminal includes positional-information acquisition means that acquires positional information on the mobile body, measurement-information acquisition means that acquires measurement information by measuring a space around the mobile body as a space to be mapped, and extraction-information generation means that generates extraction information by extraction from the measurement information based on the positional information and command information transmitted from the central apparatus to the mobile terminal. The central apparatus includes map-information generation means that generates map information based on the extraction information transmitted from the mobile terminal to the central apparatus, and map generation control means that evaluates completeness of the map information generated by the map-information generation means and generates the command information based on the completeness.

### Effects of the Invention

According to the present disclosure, the central apparatus generates command information based on the completeness of the map information. With this configuration, it is possible to appropriately reduce communication data volume.

These and other objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a block diagram illustrating a functional configuration of a map generation system according to Embodiment 1.

FIG. 2 is a block diagram illustrating a functional configuration of a mobile terminal according to Embodiment 1.

FIG. 3 is a diagram showing one example of operations of command-information selection means of the mobile terminal according to Embodiment 1.

FIG. 4 is a diagram showing one example of operations of measurement-information extraction means of the mobile terminal according to Embodiment 1.

FIG. 5 is a diagram showing one example of operations of the measurement-information extraction means of the mobile terminal according to Embodiment 1.

FIG. 6 is a diagram showing one example of operations of the measurement-information extraction means of the mobile terminal according to Embodiment 1.

FIG. 7 is a diagram showing one example of operations of the measurement-information extraction means of the mobile terminal according to Embodiment 1.

FIG. 8 is a block diagram illustrating a functional configuration of a central apparatus according to Embodiment 1.

FIG. 9 is a diagram showing one example of operations of the central apparatus according to Embodiment 1.

FIG. 10 is a diagram showing one example of the operations of the central apparatus according to Embodiment 1.

FIG. 11 is a diagram showing one example of the operations of the central apparatus according to Embodiment 1.

FIG. 12 is a diagram showing one example of the operations of the central apparatus according to Embodiment 1.

FIG. 13 is a flowchart showing one example of operations of the mobile terminal according to Embodiment 1.

FIG. 14 is a flowchart showing one example of the operations of the central apparatus according to Embodiment 1.

FIG. 15 is a block diagram illustrating a functional configuration of a map generation system according to Embodiment 2.

FIG. 16 is a diagram showing one example of the operations of a mobile terminal according to Embodiment 2.

FIG. 17 is a diagram showing one example of the operations of the mobile terminal according to Embodiment 2.

FIG. 18 is a diagram showing one example of the operations of the mobile terminal according to Embodiment 2.

FIG. 19 is a diagram showing one example of the operations of a central apparatus according to Embodiment 2.

FIG. 20 is a block diagram illustrating a functional configuration of a map generation system according to Embodiment 3.

FIG. 21 is a diagram showing one example of the operations of a central apparatus according to Embodiment 3.

FIG. 22 is a diagram showing one example of the operations of the central apparatus according to Embodiment 3.

FIG. 23 is a diagram showing one example of the operations of the central apparatus according to Embodiment 3.

FIG. 24 is a block diagram illustrating a functional configuration of a map generation system according to Embodiment 4.

FIG. 25 is a diagram showing one example of the operations of a central apparatus according to Embodiment 4.

FIG. 26 is a block diagram illustrating a hardware configuration of the central apparatus according to a variation.

FIG. 27 is a block diagram illustrating a hardware configuration of the central apparatus according to another variation.

### DESCRIPTION OF EMBODIMENTS

### Embodiment 1

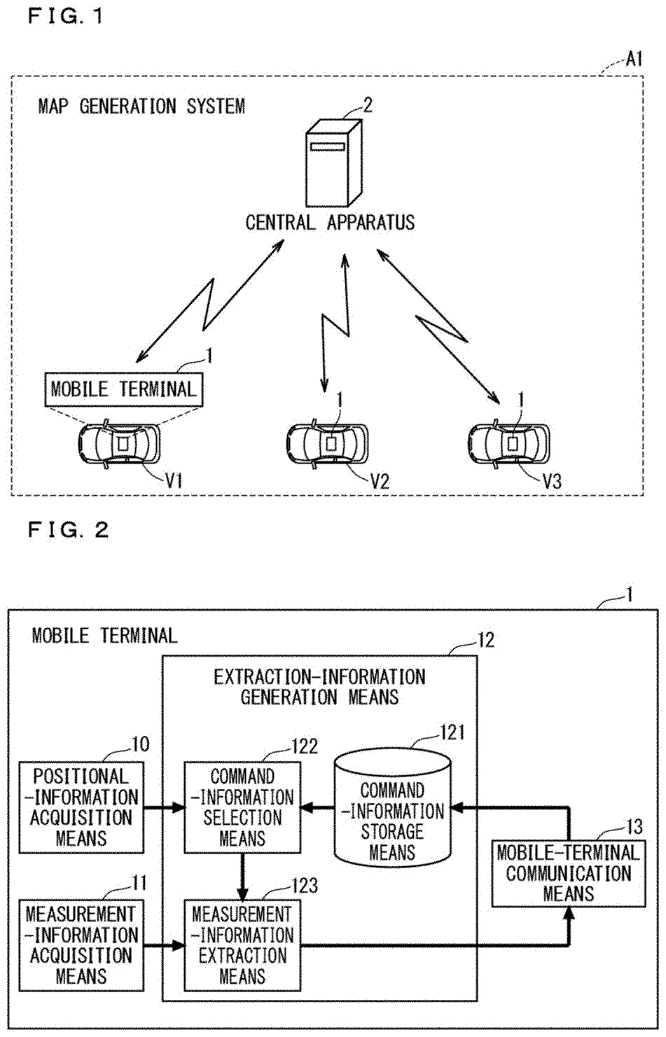

Embodiment 1 will be described with reference to the drawings. FIG. 1 is a block diagram illustrating a functional configuration of a map generation system A1 according to Embodiment 1 of the present disclosure. The map generation system A1 includes one or more mobile terminals 1 that are movable with mobile bodies V1 to V3, and a central apparatus 2 that communicates with the mobile terminals 1.

The map generation system A1 generates map information by measuring spaces around the mobile bodies V1 to V3 as spaces for which the map information is generated, i.e., spaces to be mapped, (hereinafter, also referred to as “target spaces”) and performing mapping processing based on the result of measurements. The mobile terminals 1 are movable with the mobile bodies V1 to V3 and may, for example, be mounted on the mobile bodies V1 to V3. Note that the number of mobile bodies with the mobile terminals 1 mounted thereon and the number of mobile terminals 1 are not limited to three. The central apparatus 2 is installed on the ground and generates map information based on extraction information that is extracted from the result of measuring by the mobile terminals 1.

The map information as used herein refers to information on features that exist in target spaces, the information recording either or both of the positions and shapes of the features existing in each target space with submeter positional accuracy. The map information may, for example, be road map information that records features on roads or indoor map information that records indoor features. The map information may further include attributes of features and relations of connection of the features in addition to the positions and shapes of the features.

Features include real features that actually exist in target spaces and virtual features that virtually exist in the target spaces. In the case of road map information, examples of the features include road shoulder edge, mark line, stop line, signal, road sign, road mark, street lamp, road center line, and traffic-lane center line. In the case of indoor map information, examples of the features include strut, door, illumination, air conditioner, elevator, escape leading light, virtual lane, and virtual wall.

The mobile bodies V1 to V3 may be either animals or machines each having means of transportation in target spaces. Examples of the mobile bodies include humans, vehicles, mobile robots, and drones. The mobile terminals 1 may travel in target spaces accompanying the mobile bodies. For example, the mobile terminals 1 may be mounted on the mobile bodies, or may be possessed by the mobile bodies. The following description is given on the assumption that the mobile terminals 1 are mounted on the mobile bodies.

The mobile terminals 1 and the central apparatus 2 may, for example, be calculators each configured by a storage device that stores programs and parameters, a central processing unit (CPU) that executes programs, a memory that temporarily retains the result of calculation by the CPU and programs to be executed by the CPU, and an interface for communication with other equipment.

The central apparatus 2 may, for example, be a cloud server installed on the Internet, a multi access edge computing (MEC) server installed on a core network such as a mobile telephone network, or an off-line server installed by a business company. Note that details of the hardware configurations of the mobile terminals 1 and the central apparatus 2 will be described as variations.

### Mobile Terminal 1

FIG. 2 is a block diagram illustrating a functional configuration of a mobile terminal 1 according to Embodiment 1 of the present disclosure. The mobile terminal 1 is an information processor that (i) acquires positional information on the mobile body and measurement information on surroundings of the mobile body, based on measurement results obtained by sensors mounted on the mobile body, (ii) generates, as extraction information, an extraction result extracted from the measurement information based on the positional information and the command information transmitted from the central apparatus 2 to the mobile terminal 1, and (iii) transmits the positional information and the extraction information to the central apparatus 2 and receives the command information from the central apparatus 2.

As will be described later, according to Embodiment 1 of the present disclosure, the extraction information substantially includes the positional information. Thus, when the extraction information is transmitted, both of the positional information and the extraction information are also transmitted. Alternatively, the positional information and the extraction information may be transmitted separately. In the following description, transmitting the extraction information may also be referred to as transmitting the positional information and the extraction information. Although the extraction information according to Embodiment 1 of the present disclosure includes the positional information, the extraction information does not necessary have to include the positional information.

The mobile terminal 1 includes positional-information acquisition means 10 that acquires the position of the mobile body, measurement-information acquisition means 11 that acquires measurement information by measuring a target space around the mobile body, extraction-information generation means 12 that generates extraction information extracted from the measurement information, and mobile-terminal communication means 13 that carries out information communication with the central apparatus 2.

The positional-information acquisition means 10 acquires positional information on the mobile body based on the measurement result obtained from the positioning sensor mounted on the mobile body. The measurement-information acquisition means 11 acquires measurement information by measuring a space around the mobile body as the space to be mapped, based on the measurement result obtained from the space measuring sensor mounted on the mobile body. The extraction-information generation means 12 generates, as the extraction information, partial measurement information by extraction from the measurement information based on the positional information and command information transmitted from the central apparatus 2 to the mobile terminal 1. The mobile-terminal communication means 13 carries out information communication with the central apparatus 2.

The command information is generated by the central apparatus 2 and used by the extraction-information generation means 12 of the mobile terminal 1. The command information includes a target place and a target feature type, the target place representing the place to be extracted from the measurement information through processing for extracting the extraction information, and the target feature type being a feature type that represents a feature to be extracted from the measurement information through the processing for extracting the extraction information.

The target place refers to information that represents a location or a region in the target space as a place to which the extraction processing using the command information is applied. The form of presentation of the target place may, for example, be the form of presentation using central coordinates and the distance from the central coordinates, may be the form of presentation using a sequence of coordinate points and the distances from the sequence of coordinate points, or may be the form of presentation using a region of a sequence of coordinate points.

The feature type refers to information that uniquely represents the type of one or more features in the mobile terminals 1 and the central apparatus 2, and the target feature type refers to information that represents the feature type to which the extraction processing using the command information is applied. The feature type may be a name or an identifier that is assigned to each feature in the map information, or may be a name or an identifier that collectively represents a plurality of features included in the map information. For example, the feature types in the road map information may include “road shoulder edge”, “mark line,” “stop line,” “road center line,” and “traffic-lane center line” assigned to each feature type, or may include “white line” that collectively represents a plurality of features such as “mark line” and “stop line.”

Note that the command information may further include information other than the target place and the target feature type. For example, the command information may include information such as an identifier for uniquely identifying the command information, a generation time that represents the time when the command information is generated, the term of validity that represents a period of time during which the command information is valid, and an applied condition that represents a condition for applying the command information.

Next, the constituent elements of the mobile terminal 1 will be described in detail. The positional-information acquisition means 10 is a processing unit that estimates the current location of a mobile body with the mobile terminal 1 mounted thereon, and acquires the result of the estimation as positional information. For example, the positional-information acquisition means 10 may use a positioning sensor that estimates positions to estimate the current location of a mobile body.

The positioning sensor of the positional-information acquisition means 10 may be of any kind as long as the positional information can be acquired directly or can be estimated from output values of the positioning sensor. The positioning sensor may use, for example, a global navigation satellite system (GNSS), a radio beacon, or an inertial measurement unit (IMU), or may use any combination of the above.

The positional information as used herein refers to information that uniquely indicates coordinates where the mobile body exists and the direction of travel of the mobile body as the position of the mobile body. The positional information may, for example, be expressed in the form of latitude, longitude, and azimuth angle or in the form of X coordinate, Y-coordinate, and rotation angle. The positional-information acquisition means 10 provides the positional information to the extraction-information generation means 12. Although details will be described later, the extraction-information generation means 12 that receives the positional information from the positional-information acquisition means 10 provides the positional information to the mobile-terminal communication means 13. Note that the positional-information acquisition means 10 may provide the positional information directly to the mobile-terminal communication means 13. For convenience of description, the position indicated by the positional information and the positional information may not be differentiated in the following description.

The measurement-information acquisition means 11 is a processing unit that measures a target space around the mobile body with the mobile terminal 1 mounted thereon and acquires the result of the measurement as measurement information. For example, the measurement-information acquisition means 11 may use a space measuring sensor for measuring spaces to measure the target space around the mobile body.

The space measuring sensor of the measurement-information acquisition means 11 may be of any kind as long as the relative distance between the space measuring sensor and each feature around the mobile body can be measured directly or can be estimated from the output value of the space measuring sensor. The space measuring sensor may, for example, use a laser range finder (LRF), a stereo camera, or a time of flight (ToF) camera, or may use any combination of the above.

The measurement information as used herein refers to information that includes a set of distance points each representing the relative distance between the space measuring sensor and each feature. Note that the measurement information may further include a set of color pixels. For example, the measurement information may be expressed in the form of a set of distance, azimuth angle, and angle of elevation and depression, in the form of a set of X coordinate, Y-coordinate, and Z coordinate, or in the form of a set of distance, X coordinate, and Y-coordinate. The measurement-information acquisition means 11 provides the measurement information to the extraction-information generation means 12.

The extraction-information generation means 12 is a processing unit that (i) associates and estimates feature types and feature regions from the measurement information, the feature types each indicating the type of a feature, the feature regions each indicating the region of the feature, and (ii) based on the result of determination as to whether the positional information and each feature type correspond respectively to the target place and the target feature type that are included in the command information, generates extraction information by extraction from the measurement information on the feature region corresponding to the feature type.

Specifically, the extraction-information generation means 12 (i) selects command information that is used in the generation of the extraction information, based on the result of determination as to whether the positional information corresponds to the target place included in the command information received from the central apparatus 2, (ii) associates and estimates feature types and feature regions from the measurement information, and (iii) based on the result of determination as to whether each feature type obtained by the estimation corresponds to the target feature type included in the selected command information, generates partial measurement information by extraction from the measurement information on the feature region corresponding to the feature type, as the extraction information.

The extraction-information generation means 12 transmits the extraction information to the central apparatus 2 via the mobile-terminal communication means 13. At this time, the extraction-information generation means 12 may successively transmit the extraction information to the central apparatus 2, or may transmit a plurality of extraction information by one operation to the central apparatus 2, using means for temporarily storing the extraction information.

The extraction-information generation means 12 may successively process the measurement information acquired by the measurement-information acquisition means 11, or may combine time-series data in the measurement information and process the combined data by one operation. As a method of combining time-series data in the measurement information, the data may be combined by superimposing each measurement information while using the positional information as a reference, or by performing alignment processing on a plurality of measurement information.

The extraction-information generation means 12 includes command-information storage means 121 that stores command information, command-information selection means 122 that selects command information, and measurement-information extraction means 123 that generates partial measurement information as the extraction information based on the command information selected by the command-information selection means 122.

The command-information storage means 121 is a database that stores the command information transmitted from the central apparatus 2 to the mobile terminal 1, i.e., the command information received by the mobile-terminal communication means 13, and provides the command information to the command-information selection means 122 in response to a request from the command-information selection means 122.

The command-information selection means 122 is a processing unit that (i) determines whether the positional information acquired by the positional-information acquisition means 10 corresponds to the target place included in the command information stored in the command-information storage means 121, and (ii) selects the command information that has been determined as corresponding to the positional information as command information that is used by the measurement-information extraction means 123. The command-information selection means 122 provides the selected command information or a list of the selected command information to the measurement-information extraction means 123. Although the command-information selection means 122 according to Embodiment 1 further provides the positional information to the measurement-information extraction means 123, the positional information does not necessarily have to be provided to the measurement-information extraction means 123 if the measurement information is not combined as will be described later.

In the determination method used by the command-information selection means 122, for example, it is geometrically determined whether coordinates included in the positional information are included in the position or region that represents the target place. When it is determined that the positional information is included in the target place, the command-information selection means 122 determines that the positional information corresponds to the target place included in the command information, and when it is determined that the positional information is not included in the target place, the command-information selection means 122 determines that the positional information does not correspond to the target place included in the command information.

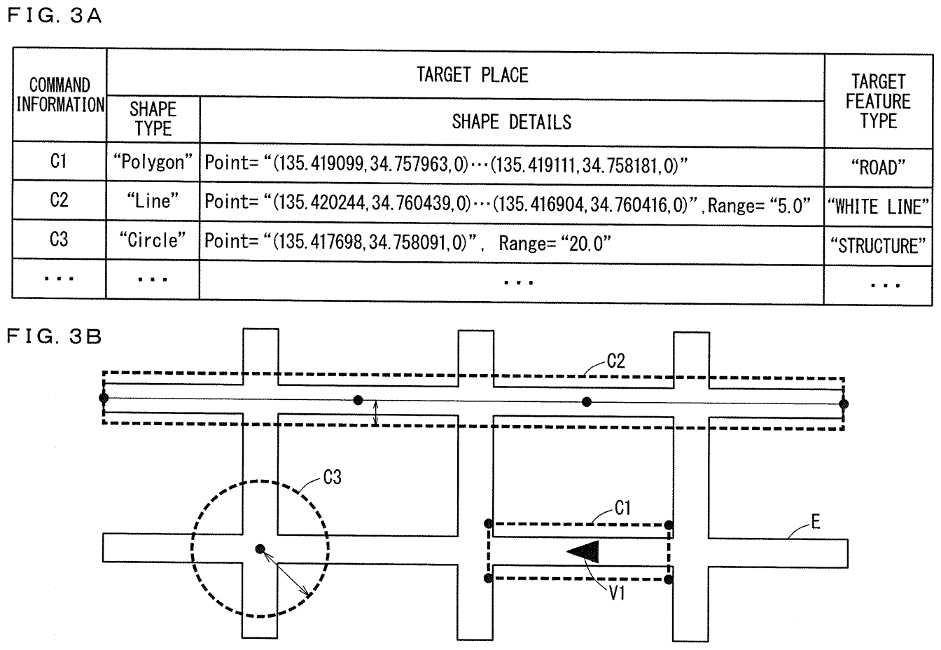

Next, one example of the operations of the command-information selection means 122 will be described with reference to the drawings. FIG. 3 is a diagram showing one example of the operations of the command-information selection means 122. FIG. 3(a) is a diagram illustrating command information C1 to C3 stored in the command-information storage means 121. Each of the command information C1 to C3 includes a target place and a target feature type, the target place being designated by a shape type and shape details. FIG. 3(b) is a diagram illustrating the mobile body V1 with the mobile terminal 1 mounted thereon, a target space E that is a space around the mobile body V1 and in which the mobile body V1 travels, and target places included in the command information C1 to C3. In FIG. 3(b), the broken lines indicate the target places included in the command information C1 to C3.

First, the command-information selection means 122 determines whether the positional information on the mobile body V1 corresponds to the target place included in the command information C1. The command-information selection means 122 compares the positional information on the mobile body V1 with the target place included in the command information C1, and if the mobile body V1 exists in the target place included in the command information C1 as illustrated in FIG. 3(b), determines that the positional information on the mobile body V1 corresponds to the target place included in the command information C1. In this case, the command-information selection means 122 selects the command information C1 as command information that is used by the measurement-information extraction means 123.

Next, as in the case of the command information C1, the command-information selection means 122 determines whether the positional information on the mobile body V1 corresponds to the target place included in the command information C2. If the mobile body V1 exists outside the target place included in the command information C2 as illustrated in FIG. 3(b), the command-information selection means 122 determines that the positional information on the mobile body V1 does not correspond to the target place included in the command information C1.

Then, as in the case of the command information C1 and C2, the command-information selection means 122 determines whether the positional information on the mobile body V1 corresponds to the target place included in the command information C2. If the mobile body V1 exists outside the target place included in the command information C3 as illustrated in FIG. 3(b), the command-information selection means 122 determines that the positional information on the mobile body V1 does not correspond to the target place included in the command information C3.

As a result of the above, the command-information selection means 122 provides the selected command information C1 to the measurement-information extraction means 123.

The descriptions will now return to the mobile terminal 1 illustrated in FIG. 2. The measurement-information extraction means 123 is a processing unit that, based on the positional information, the measurement information, and the command information selected by the command-information selection means 122, (i) combines one or more measurement information, (ii) associates and estimates feature types and feature regions from the measurement information, and (iii) based on the result of determination as to whether each feature type corresponds to the target feature type included in the command information, generates extraction information by extraction from the measurement information on the feature region corresponding to the feature type. Hereinafter, the measurement-information extraction means 123 will be described in detail.

First, the measurement-information extraction means 123 adjusts reference positions of multiple measurement information, which are acquired by the measurement-information acquisition means 11, by rotating or translating the multiple measurement information based on multiple positional information acquired by the positional-information acquisition means 10 and the multiple measurement information, and combines the multiple measurement information. In the case of using only one measurement information, the measurement-information extraction means 123 may skip this processing of combining the measurement information and as a result does not use the positional information.

Next, the measurement-information extraction means 123 applies feature estimation processing to the measurement information combined through the combining processing so as to associate and estimate feature types and feature regions, the feature types each representing the type of a feature included in the measurement information, and the feature regions each representing the region where the feature exists.

Then, if it is determined that the feature type obtained by the aforementioned estimation corresponds to the target feature type included in the command information selected by the command-information selection means 122, the measurement-information extraction means 123 selects this feature type.

Finally, the measurement-information extraction means 123 extracts a subset of the measurement information that corresponds to the feature region corresponding to the selected feature type, and generates the result of the extraction as extraction information. Note that the feature region corresponding to the selected feature type is the feature region that is estimated with the selected feature type. In addition to the subset of the measurement information that corresponds to the aforementioned feature region, the measurement-information extraction means 123 may further extract a subset of the measurement information that corresponds to the surroundings of the aforementioned feature region, and generates the result of the extraction as the extraction information. The measurement-information extraction means 123 provides the generated extraction information to the mobile-terminal communication means 13.

The feature region as used herein refers to the range (region) in the target space or the range (region) in the measurement information, which are both estimated to include a feature as a result of the feature detection processing. The feature region may only need to represent the range where the feature exists and may be expressed as, for example, a rectangular parallelepiped that surrounds the feature, a polyhedron that is shaped according to the shape of the feature, or a rectangle that surrounds the feature in a two-dimensional bird's eye plan view.

The feature estimation processing performed by the measurement-information extraction means 123 may be estimation processing for estimating the feature type and the feature region from the measurement information. For example, the feature estimation processing may be performed by a geometric estimation method in which a feature that is associated in advance with a threshold value preset for each feature type, such as position, shape, or size, is estimated based on the threshold value. As another alternative, the feature estimation processing may be performed by, for example, a model estimation method in which a feature is estimated by a random extraction consensus (RANSAC) method using a model that is preset for each feature type. As yet another alternative, the feature estimation processing may be performed by, for example, an estimation method using machine learning in which the feature type and the feature region are detected using a convolutional neural network for estimation of the feature type and the feature region.

The number of command information selected by the command-information selection means 122 may be zero or two or more. In the case where the number of command information is zero, the measurement-information extraction means 123 may extract the measurement information by using a default feature type that is set in advance, may stop the extraction, or may extract the measurement information by using all the feature types. In the case where the number of command information is two or more, the measurement-information extraction means 123 may integrate multiple extraction information into one extraction information, or may handle multiple extraction information as-is.

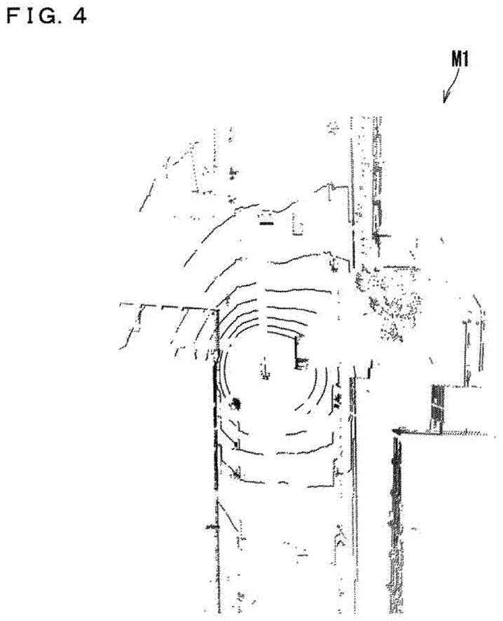

Next, one example of the operations of the measurement-information extraction means 123 will be described with reference to the drawings. FIGS. 4 to 7 are diagrams showing one example of the operations of the measurement-information extraction means 123. In the example illustrated in FIGS. 4 to 7, the target feature type included in the command information is assumed to be “utility pole.”

First, the measurement-information extraction means 123 acquires measurement information M1 as illustrated in FIG. 4 from the measurement-information acquisition means 11. FIG. 4 is a bird's eye view of the measurement information M1, the measurement information M1 being expressed as a point group of relative distances centered on the mobile body.

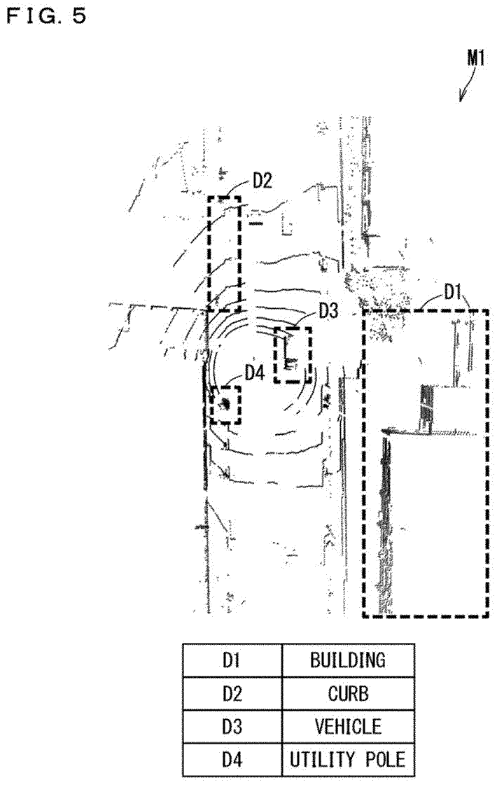

Next, the measurement-information extraction means 123 performs feature estimation processing on the measurement information M1 and obtains the result of estimation as illustrated in FIG. 5. FIG. 5 is a diagram illustrating four features D1 to D4 estimated (detected) from the measurement information M1. FIG. 5 shows the result of estimating (detecting) the feature type and the feature region through the feature detection processing. The feature types of the features D1 to D4 are respectively “building,” “curb,” “vehicle,” and “utility pole,” and the feature regions of the features D1 to D4 are indicated by broken frames.

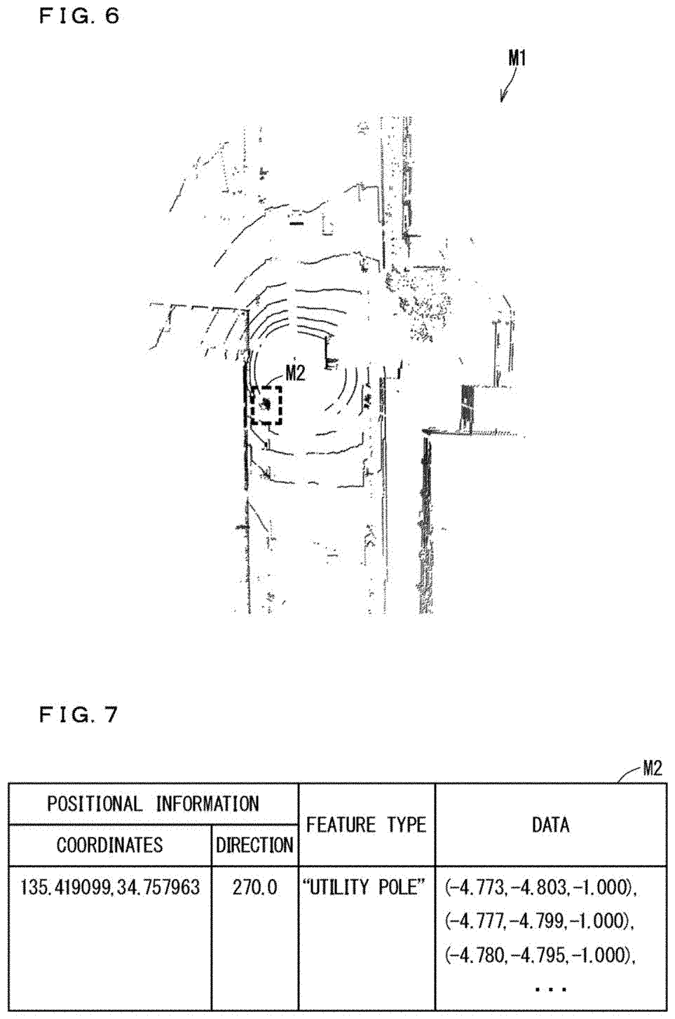

Finally, the measurement-information extraction means 123 determines whether each of the feature types of the features D1 to D4 corresponds to the target feature type of “utility pole” included in the command information. In the example illustrated in FIG. 5, the feature type of the feature D4 is determined to correspond to the target feature type. The measurement-information extraction means 123 extracts information on the feature region of the feature D4 from the measurement information M1 to generate extraction information M2 as illustrated in FIGS. 6 and 7. Note that FIG. 6 is a bird's eye view of the extraction information M2. FIG. 7 is a diagram that represents the extraction information M2.

According to Embodiment 1 of the present disclosure, the extraction information includes, as illustrated in FIG. 7, positional information that is used as the reference position of the measurement information, data that represents a subset of distance data on the feature region, extracted from the measurement information, and the feature type of the feature that corresponds to the target feature type and that is indicated by the above data.

The description will now return to the mobile terminal 1 illustrated in FIG. 2. The mobile-terminal communication means 13 is a communicator that carries out information communication with the central apparatus 2. The mobile-terminal communication means 13 transmits the extraction information provided by the extraction-information generation means 12 to the central apparatus 2, and receives the command information from the central apparatus 2 and provides the received command information to the extraction-information generation means 12. Since the extraction information according to Embodiment 1 of the present disclosure includes the positional information and the feature type, the positional information and the feature type are also transmitted to the central apparatus 2 by the transmission of the extraction information to the central apparatus 2.

The communication system used by the mobile-terminal communication means 13 may be of any kind as long as communication is possible between the central apparatus 2 and the moving mobile terminal 1. For example, wide-area radio frequency communication such as long term evolution (LTE) or world interoperability for microwave access (WiMAX) may be used, narrow-area radio frequency communication such as 5-Generation (5G), wireless local area network (LAN), Bluetooth (registered trademark), or dedicated short range communication (DSRC) may be used, or a mobile communication system using light or sound other than radio waves may be used. The mobile terminal 1 and the central apparatus 2 do not necessarily have to carry out direct information communication, and may carry out information communication via a cable communication network or a wireless communication network.

### Configuration of Central Apparatus 2

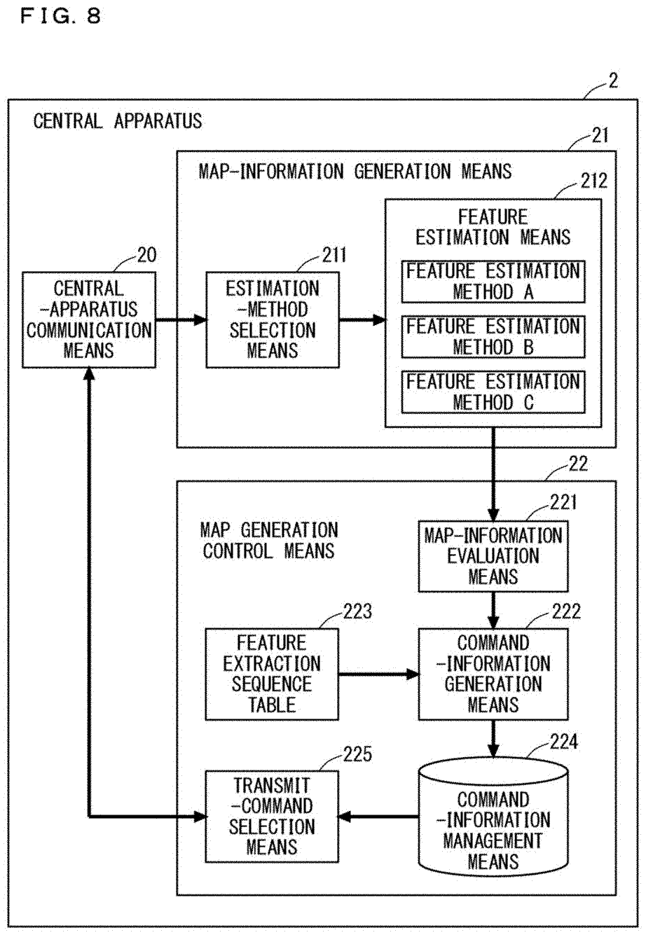

Next, details of the central apparatus 2 will be described with reference to FIG. 8. FIG. 8 is a block diagram illustrating a functional configuration of the central apparatus 2 according to Embodiment 1 of the present disclosure.

The central apparatus 2 is an information processor that (i) generates map information based on the extraction information provided by a mobile terminal 1, (ii) evaluates completeness of the map information, (iii) generates command information based on the completeness, and (iv) selects and transmits the command information to the mobile terminal 1.

The central apparatus 2 includes central-apparatus communication means 20 that carries out information communication with each mobile terminal 1, map-information generation means 21 that generates map information based on extraction information, and map generation control means 22 that generates command information based on the map information.

The central-apparatus communication means 20 is a communicator that carries out information communication with each mobile terminal 1. The central-apparatus communication means 20 receives extraction information from a mobile terminal 1 and provides the extraction information (the positional information and the feature type) to the map-information generation means 21 and the map generation control means 22, and transmits the command information generated by the map generation control means 22 to the mobile terminal 1.

The communication system used by the central-apparatus communication means 20 may be of any kind as long as communication is possible between the central apparatus 2 and a moving mobile terminal 1 and may, for example, be the same as the communication system used by the mobile-terminal communication means 13.

The map-information generation means 21 is a processing unit that (i) selects a feature estimation method for each feature type included in the extraction information based on the extraction information provided by one or more mobile terminals 1, and (ii) generates map information for each feature type, using the selected feature estimation method.

The map-information generation means 21 includes estimation-method selection means 211 that selects a feature estimation method from among a plurality of feature selection methods, and feature estimation means 212 that estimates the positions or shapes of features, using the feature estimation method selected by the estimation-method selection means 211. Note that the feature estimation means 212 prepare a plurality of feature estimation methods for each feature type, and in the example illustrated in FIG. 8, feature estimation methods A to C are prepared.

The estimation-method selection means 211 is a processing unit that selects, from among a plurality of feature estimation methods, a feature estimation method that corresponds to the feature type included in the extraction information transmitted from the mobile terminal 1 to the central apparatus 2, as feature estimation means that is used by the feature estimation means 212.

The correspondence between the feature types and the feature estimation methods is set in advance, and the estimation-method selection means 211 retrieves, from the correspondence, the same feature type as the feature type included in the extraction information. Then, the estimation-method selection means 211 selects, from among the feature estimation methods, a feature estimation method that corresponds to the above feature type as feature estimation means that is used by the feature estimation means 212.

The feature estimation means 212 is a processing unit that (i) estimates the positions or shapes of features, using the feature estimation method selected by the estimation-method selection means 211, (ii) improves the accuracy of the positions or shapes of the features by appropriately applying statistical processing, and (iii) generates map information for each feature type based on the position or shape of the feature.

For example, the feature estimation means 212 first corrects the reference position indicated by the positional information included in the extraction information, using the feature estimation method, if any map information is in preparation. Next, the feature estimation means 212 performs feature estimation processing such as geometric calculation, model estimation, or machine learning on the extraction information to estimate the positions or shapes of features. Then, the feature estimation means 212 performs matching of the currently estimated feature and each previously estimated feature based on the feature type included in the extraction information and the position or shape of the feature so as to estimate the same feature, or appropriately applies statistical processing on the features so as to improves the accuracy of the positions or shapes of the features. Finally, the feature estimation means 212 generates or updates map information for each feature type by recording the result of estimating the map information for each feature type. At this time, if there are already different map information for a plurality of feature types, the feature estimation means 212 may integrate these map information.

The map generation control means 22 is a processing unit that (i) evaluates the completeness of the map information generated by the map-information generation means 21 and (ii) while switching the target feature type according to the completeness, generates and selects command information that includes the target feature type. The map generation control means 22 switches the target feature type in a predetermined order of completeness based on the completeness of the map information. For example, in a map generation system for generating road map information, the map generation control means 22 switches the target feature type in the order of “road, “white line,” and “structure.”

The map generation control means 22 includes map-information evaluation means 221, command-information generation means 222, a feature extraction sequence table 223, command-information management means 224, and transmit-command selection means 225.

The map-information evaluation means 221 evaluates the completeness of the map information generated by the map-information generation means 21. The map-information evaluation means 221 may evaluate the completeness of the map information generated by the map-information generation means 21, collectively for all target feature types or separately for each target feature type.

The feature extraction sequence table 223 shows the correspondence between the completeness and the target feature types. While switching the target feature type corresponding to the completeness according to the feature extraction sequence table 223, the command-information generation means 222 generates command information that includes the target feature type, based on the completeness evaluated by the map-information evaluation means 221. The command-information management means 224 manages the command information generated by the command-information generation means 222, by registering, storing, or deleting the command information.

The transmit-command selection means 225 predicts an accessible range that represents the range that the mobile terminal 1 can reach, based on the positional information included in the extraction information transmitted from the mobile terminal 1 to the central apparatus 2. Then, the transmit-command selection means 225 selects command information that is to be transmitted from the central apparatus 2 to the mobile terminal 1, from the command-information management means 224 based on the accessible range and the target place included in the command information.

Next, each constituent element of the map generation control means 22 will be described in detail. The map-information evaluation means 221 is a processing unit that (i) evaluates the positional accuracy of features included in the map information generated by the map-information generation means 21, based on the map information and (ii) calculates the completeness of the map information based on the result of the evaluation.

Specifically, the map-information evaluation means 221 first determines an evaluation range that is the range to be evaluated, out of the range indicated by the map information. The evaluation range is the range that is included in the range indicated by the map information.

The method of determining the evaluation range used by the map-information evaluation means 221 may be of any kind as long as one or more evaluation ranges can be determined from the map information by, for example, dividing the map information into one or more ranges (regions). For example, the map-information evaluation means 221 may determine one or more cells that are divided in a preset grid as evaluation ranges. Alternatively, for example, the map-information evaluation means 221 may determine a range that is updated by the map-information generation means 21 as an evaluation range. As another alternative, for example, the map-information evaluation means 221 may acquire points of division between features (e.g., branch points of roads) based on the map information in preparation and determines ranges that are divided by the points of division and in which features exist, as evaluation ranges.

Next, the map-information evaluation means 221 evaluates reliability that represents the degree of reliability of the positional accuracy of features in each evaluation range and calculates the completeness of the map information based on the result of evaluation of the reliability.

The method of evaluating positional accuracy used by the map-information evaluation means 221 may be of any kind as long as the completeness can be evaluated as higher as the positional accuracy increases. For example, based on the number of times that features of the feature type are measured in the evaluation range, the map-information evaluation means 221 may evaluate the completeness as higher as this number of times increases. Alternatively, for example, based on the time of measurement for the evaluation range, the map-information evaluation means 221 may evaluate the completeness as higher as this time of measurement increases. As another alternative, for example, the map-information evaluation means 221 may evaluate the completeness as higher as improves with the number of fluctuation errors in the positions of features decreases, based on the result of statistical processing performed by the map-information generation means 21.

The completeness as used herein refers to an index that represents the degree of completeness of the whole or part of the map information. The completeness may be any information that enables determining in which stage the process of generating the map information is. For example, the completeness may be the feature type and the positional accuracy of the feature type as-is, or may be a value obtained by converting the feature type and the positional accuracy of the feature type into numbers. The value obtained by converting the feature type and the positional accuracy of the feature type into numbers may be a value obtained by converting the feature type and the positional accuracy of the feature type into a truth or false value, using a threshold value, may be a value obtained by normalization of the feature type and the positional accuracy of the feature type, or may be a numeric value or an identifier that represents the process of generating a map from the start to the end as continuous values by converting the feature type and the positional accuracy of the feature type, using a preset list.

The command-information generation means 222 is a processing unit that retrieves, based on the completeness evaluated by the map-information evaluation means 221, the target feature type that corresponds to the completeness according to the feature extraction sequence table 223 and generates command information that includes the target feature type to be extracted.

The command-information generation means 222 generates command information that includes, as the target place, the entire or part of the evaluation range determined by the map-information evaluation means 221. As described above, the command information generated by the command-information generation means 222 includes the entire or part of the evaluation range determined by the map-information evaluation means 221 as the target place, and also includes the target feature type that is indexed by completeness in the feature extraction sequence table 223.

The feature extraction sequence table 223 is an index table that shows the target feature type to be extracted by the mobile terminal 1 on a completeness basis. For example, in a map generation system for generating road map information, if the completeness is evaluated in three stages, a completeness of “1” may be set as “road,” a completeness of “2” may be set as “white line,” and a completeness of “3” may be set as “structure” in the feature extraction sequence table 223

Note that, in the feature extraction sequence table 223, one target feature type may be listed multiple times. For example, in a map generation system for generating road map information, if the completeness is evaluated in four stages, a completeness of “1” may be set as a first iteration of “road,” a completeness of “2” may be set as “white line,” a completeness of “3” may be set as “structure,” and a completeness of “4” may be set as a second iteration of “road” in the feature extraction sequence table 223.

The command-information management means 224 is a database that manages one or more command information generated by the command-information generation means 222, by registering, storing, or deleting the command information and provides command information in response to a request from the transmit-command selection means 225.

Note that the command-information management means 224 may also retain the completeness calculated by the map-information evaluation means 221, in addition to the command information. In that case, the command-information generation means 222 may determine the command information with reference to the completeness.

The transmit-command selection means 225 is a processing unit that (i) predicts the accessible range of a mobile terminal 1 based on the positional information included in the extraction information transmitted from the mobile terminal 1 to the central apparatus 2, (ii) selects command information that includes a target place in the accessible range from among the command information stored in the command-information management means 224, and (iii) transmits the command information to the mobile terminal 1 via the central-apparatus communication means 20.

In the processing for predicting the accessible range, for example, the transmit-command selection means 225 may predict, as the accessible range, a range that is located within a certain distance (e.g., within three kilometers) from the position indicated by the positional information as the center, based on the positional information transmitted from the mobile terminal 1. Alternatively, in the processing for predicting the accessible range, for example, the transmit-command selection means 225 may predict, as the accessible range, a range that the mobile body can reach within a certain period of time (e.g., in five minutes), using the position indicated by the positional information as the center. As another alternative, for example, the transmit-command selection means 225 may predict, as the accessible range, a route that exists within a certain range of distances from the position of the mobile body indicated by the positional information, based on information on the route and the positional information. As yet another alternative, the transmit-command selection means 225 may predict a range that is set by the user of the central apparatus 2 as the accessible range.

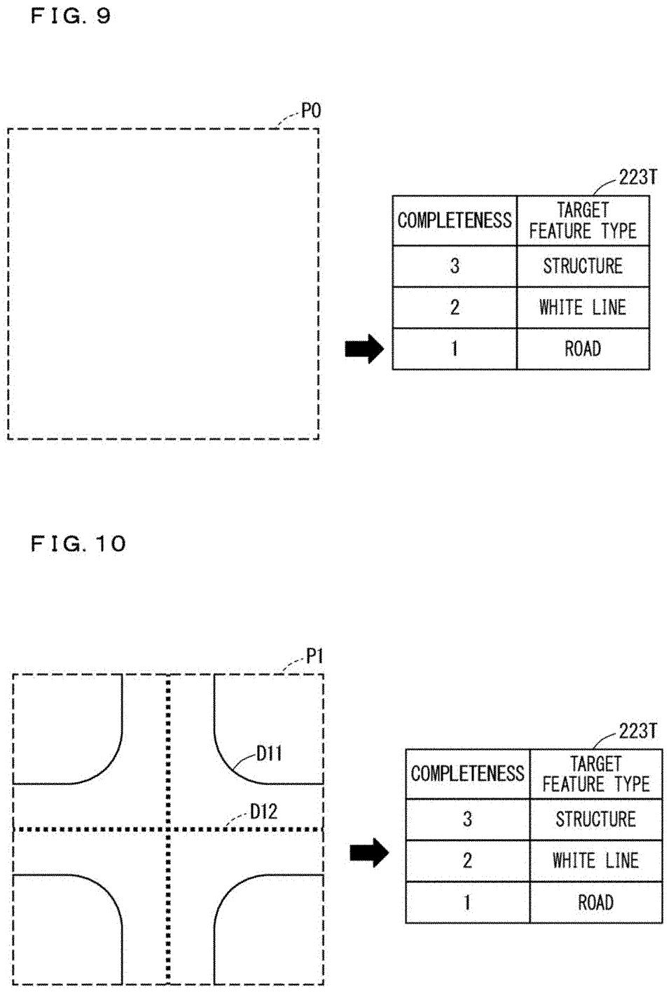

Next, one example of the operations of the central apparatus 2 will be described with reference to the drawings. FIGS. 9 to 12 are diagrams showing one example of the operations of the central apparatus 2. It is assumed herein that the central apparatus 2 generates road map information. In the example illustrated in FIGS. 9 to 12, a case is assumed in which the central apparatus 2 evaluates the completeness in three stages of “1,” “2,” and “3” and the target feature types include “road,” “white line,” and “structure.”

FIG. 9 is a diagram illustrating the initial state of the central apparatus 2. FIG. 9 illustrates map information P0 generated by the map-information generation means 21 and a feature extraction sequence table 223T stored in the map generation control means 22. In the feature extraction sequence table 223T illustrated in FIG. 9, a completeness of “1” corresponds to the target feature type of “road,” a completeness of “2” corresponds to the target feature type of “white line,” and a completeness of “3” corresponds to the target feature type of “structure.” Since the map information has the lowest completeness of “1” in the initial state, the map generation control means 22 generates command information that includes the target feature type of “road.”

FIG. 10 is a diagram illustrating a first state of the central apparatus 2 after the initial state. The map-information generation means 21 generates map information P1 that includes the target feature type of “road” based on the extraction information transmitted from the mobile terminal 1 that has received the command information. In FIG. 10, a road shoulder edge D11 and a road center line D12 correspond to the target feature type of “road” included in the map information P1. The map generation control means 22 evaluates the map information P1, and when it is determined that the map information on the target feature type of “road” is completed, the map generation control means 22 changes the completeness from “1” to “2.” Following this, the map generation control means 22 generates command information that includes the target feature type of “white line” according to the feature extraction sequence table 223T.

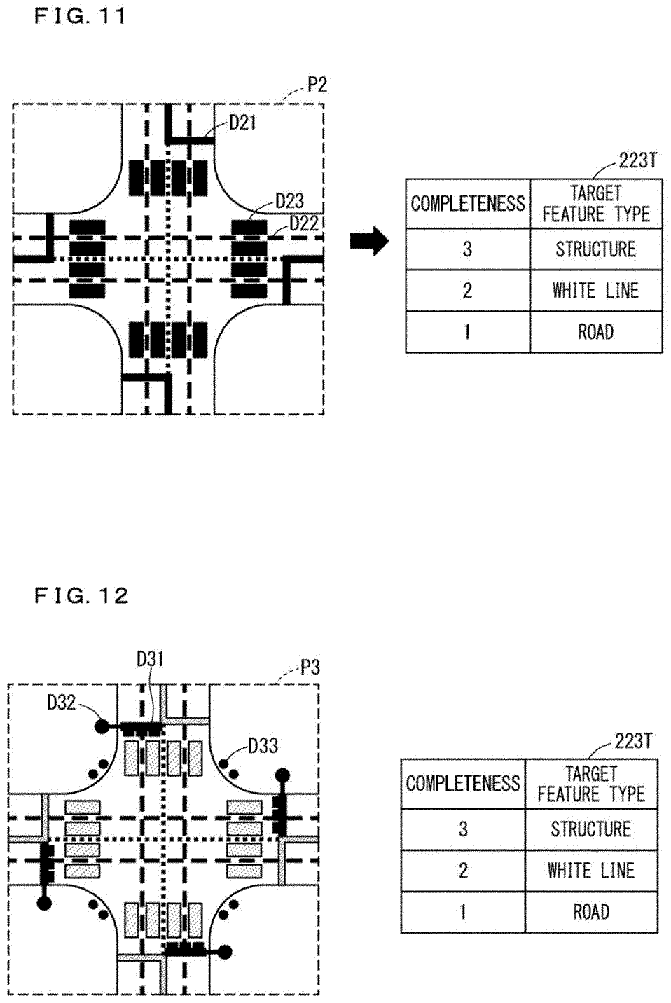

FIG. 11 is a diagram illustrating a second state of the central apparatus 2 after the first state. The map-information generation means 21 generates map information P2 that includes the target feature types of “road” and “white line” based on the extraction information transmitted from the mobile terminal 1 that has received the command information. In FIG. 11, a mark line D21, a traffic-lane center line D22, and a pedestrian crossing D23 correspond to the target feature type of “white line” included in the map information P2. The map generation control means 22 evaluates the map information P2, and when it is determined that the map information on the target feature type of “white line” is completed, the map generation control means 22 changes the completeness from “2” to “3.” Following this, the map generation control means 22 generates command information that includes the target feature type of “structure” according to the feature extraction sequence table 223T.

Finally, FIG. 12 is a diagram illustrating a third state of the central apparatus 2 after the second state. The map-information generation means 21 generates map information P3 that includes the target feature types of “road,” “white line,” and “structure,” based on the extraction information transmitted from the mobile terminal 1 that has received the command information. In FIG. 12, a signal D31, a utility pole D32, and a pole D33 correspond to the target feature type of structure” included in the map information P3. The map generation control means 22 evaluates the map information P3, and when it is determined that the map information on the target feature type of “structure” is completed, the map generation control means 22 determines that the map information is completed.

### Operations of Mobile Terminal 1

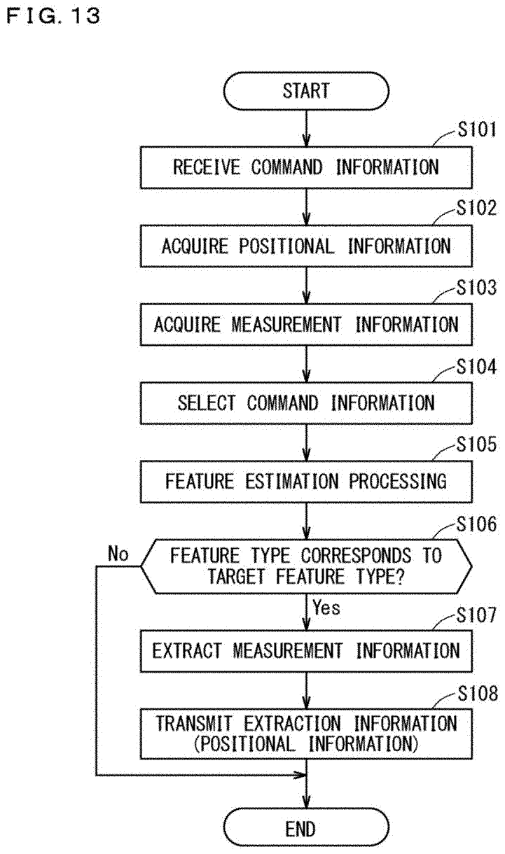

Next, one example of the operations of a mobile terminal 1 in the map generation system A1 according to Embodiment 1 of the present disclosure will be described with reference to the drawings. FIG. 13 is a flowchart showing one example of the operations of a mobile terminal 1 in the map generation system A1.

First, in step S101, the mobile-terminal communication means 13 of the mobile terminal 1 receives command information transmitted from the central apparatus 2. In step S101, the mobile-terminal communication means 13 also provides the command information to the command-information storage means 121. When step S101 is completed, the procedure proceeds to step S102.

In step S102, the positional-information acquisition means 10 acquires positional information on the mobile body and provides the acquired positional information to the command-information selection means 122. When step S102 is completed, the procedure proceeds to step S103.

In step S103, the measurement-information acquisition means 11 acquires measurement information on the surroundings of the mobile body and provides the acquired measurement information to the measurement-information extraction means 123. When step S103 is completed, the procedure proceeds to step S104.

In step S104, the command-information selection means 122 selects (retrieves) command information from the command-information storage means 121 based on the positional information acquired in step S102. When step S104 is completed, the procedure proceeds to step S105.

In step S105, the measurement-information extraction means 123 performs feature estimation processing based on the measurement information acquired in step S103 and associates and estimates feature types and feature regions. When step S105 is completed, the procedure proceeds to step S106.

In step S106, the measurement-information extraction means 123 determines whether the feature type estimated in step S105 corresponds to the target feature type included in the command information selected in step S104. When it is determined that the feature type does not correspond to the target feature type, the series of processing in FIG. 13 is completed without transmission of the extraction information. When it is determined that the feature type corresponds to the target feature type, the procedure proceeds to step S107 in order to transmit the extraction information.

In step S107, the measurement-information extraction means 123 extracts part of the measurement information based on the feature region corresponding to the future type that is determined as corresponding to the target feature type in step S106, and generates the result of the extraction as extraction information. Then, the measurement-information extraction means 123 provides the generated extraction information to the mobile-terminal communication means 13. When step S107 is completed, the procedure proceeds to step S108.

In step S108, the mobile-terminal communication means 13 transmits the extraction information generated in step S107 to the central apparatus 2. Since the extraction information according to Embodiment 1 of the present disclosure includes the positional information and the feature type, the positional information and the feature type are also transmitted to the central apparatus 2, together with the extraction information. If the mobile terminal 1 is configured not to include the positional information and the feature type in the extraction information, the extraction information, the positional information, and the feature type may be transmitted separately to the central apparatus 2. When step S108 is completed, the series of processing in FIG. 13 is completed. Although not shown in FIG. 13, the procedure may return to step S101 after the completion of step S108.

In the above description, the sequence of the processing in steps S101 to S103 may be interchanged, or may be executed in parallel. The processing in step S101 does not necessarily have to be executed in the initial state. Specifically, the processing in step S101 may be executed only when the series of processing is completed and the central apparatus 2 has transmitted the command information.

### Operations of Central Apparatus 2

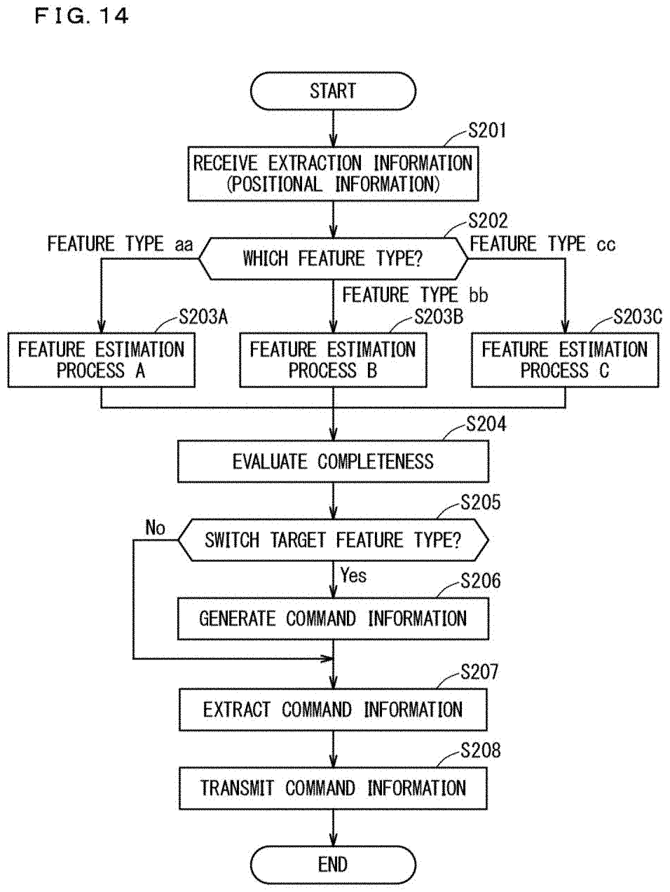

Next, one example of the operations of the central apparatus 2 in the map generation system A1 according to Embodiment 1 of the present disclosure will be described with reference to the drawings. FIG. 14 is a flowchart showing one example of the operations of the central apparatus 2 in the map generation system A1.

First, in step S201, the central-apparatus communication means 20 of the central apparatus 2 receives extraction information transmitted from a mobile terminal 1. In step S201, the central-apparatus communication means 20 also provides the extraction information to the map-information generation means 21 and the map generation control means 22. Since the extraction information according to Embodiment 1 of the present disclosure includes the positional information and the feature type, the central-apparatus communication means 20 receives and provides the positional information and the feature type, together with the extraction information. In the case where the mobile terminal 1 is configured not to include the positional information and the feature type in the extraction information, the central-apparatus communication means 20 may separately receive and provide the extraction information, the positional information, and the feature type. When step S201 is completed, the procedure proceeds to step S202.

In step S202, the estimation-method selection means 211 of the map-information generation means 21 selects a feature estimation method that is executed in the next step, based on the feature type included in the extraction information acquired in step S201. By way of example, FIG. 14 illustrates feature estimation processes a to c that are respectively performed by the three feature estimation methods A to C illustrated in FIG. 5. In the case where the feature type included in the extraction information is a feature type aa, the procedure proceeds to step S203A. In the case where the feature type included in the extraction information is a feature type bb, the procedure proceeds to step S203B. In the case where the feature type included in the extraction information is a feature type cc, the procedure proceeds to step S203C.

In steps S203A to S203C, the feature estimation means 212 of the map-information generation means 21 generates map information by performing the feature estimation methods A to C based on the extraction information that includes the positional information acquired in step S201, and provides the generated map information to the map generation control means 22. When any of steps S203A to S203C is completed, the procedure proceeds to step S204.

In step S204, the map-information evaluation means 221 of the map generation control means 22 calculates completeness by evaluating the map information generated in steps S203A to S203C and provides the calculated completeness to the command-information generation means 222 of the map generation control means 22. When step S204 is completed, the procedure proceeds to step S205.

In step S205, the command-information generation means 222 of the map generation control means 22 determines, based on the completeness obtained by the calculation in step S204, whether or not to switch the target feature type, i.e., the feature type to be extracted by the mobile terminal 1, according to the feature extraction sequence table 223. In the case of switching the target feature type, the procedure proceeds to step S206. In the case of not switching the target feature type, the procedure proceeds to step S207.

In step S206, the command-information generation means 222 of the map generation control means 22 generates command information that includes the target place and the target feature type, based on the map information generated in steps S203A to S203C and the target feature type determined in step S205 and stores the generated command information in the command-information management means 224. When step S206 is completed, the procedure proceeds to step S207.

In step S207, the transmit-command selection means 225 of the map generation control means 22 predicts the accessible range based on the positional information included in the extraction information acquired in step S201. Then, the transmit-command selection means 225 selects (extracts) command information that includes the target place located in the accessible range, from the command information stored in step S206 and provides the selected command information to the central-apparatus communication means 20. When step S207 is completed, the procedure proceeds to step S208.

In step S208, the central-apparatus communication means 20 transmits the command information selected in step S207 to the mobile terminal 1. When step S208 is completed, the series of processing in FIG. 14 is completed. Although not illustrated in FIG. 14, the procedure may return to step S201 after completion of step S208.

In the above description, the sequence of the processing performed in steps S201 and S202 may be interchanged, or may be executed in parallel. In the case where only the positional information has been acquired in step S201, only the processing in steps S207 and S208 may be executed.

### Summary of Embodiment 1

According to Embodiment 1 of the present disclosure as described above, the map generation control means 22 evaluates the completeness of the map information to generate command information that includes the target feature type corresponding to the completeness. The extraction-information generation means 12 generates extraction information based on the result of determination as to whether the feature type estimated from the measurement information corresponds to the target feature type included in the command information. This allows the map generation system A1 to reduce the volume of information that is transmitted from the mobile terminal 1 to the central apparatus 2, to the volume of information on the target feature type, i.e., the volume of information that is necessary for the central apparatus 2 to generate map information without using existing map information. Accordingly, it is possible to appropriately reduce communication data volume.

The map generation control means 22 further designates the target feature type that is included in the command information in order based on the feature extraction sequence table 223 that is set in advance. This allows the map generation system A1 to preferentially generate map information that includes the target feature type of high importance.

Besides, the map generation control means 22 predicts the accessible range based on the positional information transmitted from the mobile terminal 1 to the central apparatus 2 and determines the command information that is to be transmitted from the central apparatus 2 to the mobile terminal 1, based on the accessible range and the target place included in the command information. This allows the map generation system A1 to improve the reliability of providing the command information to the mobile terminal 1 while reducing the number of times the command information is transmitted.

Moreover, the map-information generation means 21 selects a feature estimation method based on the feature type included in the extraction information. This eliminates the need for the map generation system A1 to perform the estimation processing on every feature type assumed by the central apparatus 2 and accordingly results in a reduction in processing load on the central apparatus 2.

### Embodiment 2

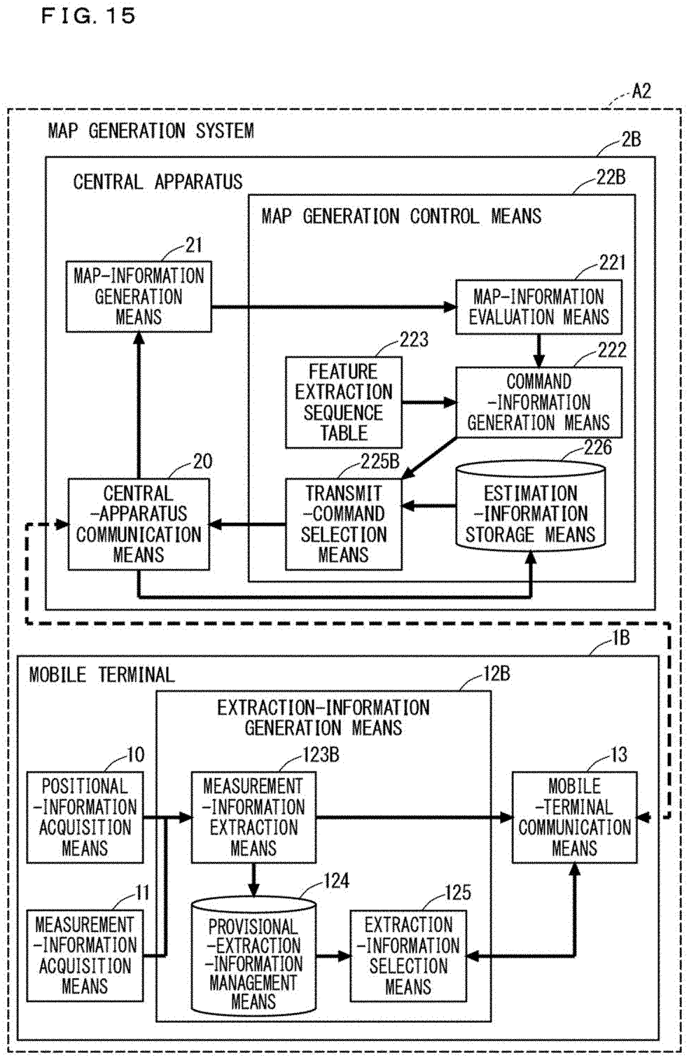

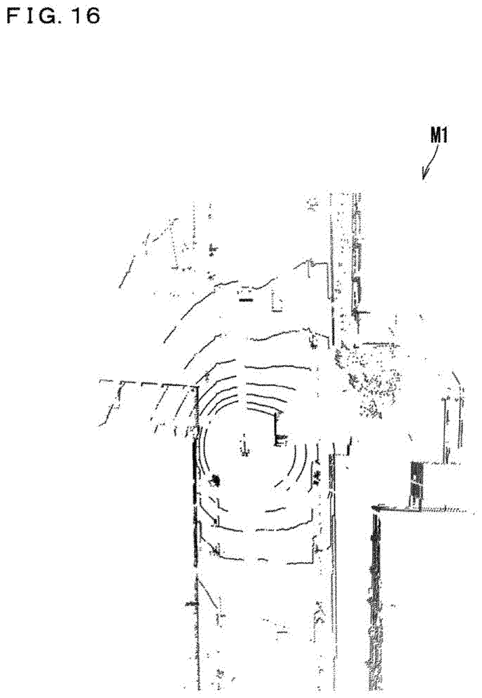

Embodiment 2 of the present disclosure will now be described with reference to the drawings. FIG. 15 is a block diagram illustrating a functional configuration of a map generation system A2 according to Embodiment 2 of the present disclosure. Note that the basic configuration of the map generation system A2 according to Embodiment 2 of the present disclosure is similar to the configuration of the map generation system A1 according to Embodiment 1, and therefore the following description mainly focuses on points of difference.

The points of difference between the map generation system A1 according to Embodiment 1 and the map generation system A2 according to Embodiment 2 of the present disclosure are as follows. In the map generation system A1 according to Embodiment 1, the central apparatus generates command information in advance, whereas the mobile terminals generate extraction information by sequential positioning and measurement.

In the map generation system A2 according to Embodiment 2 of the present disclosure, on the other hand, each mobile terminal first generates provisional extraction information by pre-positioning and pre-measurement, the provisional extraction information being a candidate for the extraction information. The central apparatus generates and transmits command information with arbitrary timing. The mobile terminal selects extraction information that is to be transmitted to the central apparatus, from the provisional extraction information based on the command information.

As illustrated in FIG. 15, the map generation system A2 includes one or more mobile terminals 1B and a central apparatus 2B, instead of the mobile terminals 1 and the central apparatus 2 in the map generation system A1 according to Embodiment 1.

Each mobile terminal 1B (i) generates provisional extraction information and estimation information from positional information and measurement information, (ii) stores the provisional extraction information, and (iii) selects extraction information that is to be transmitted to the central apparatus 2B, from the stored provisional extraction information based on the command information transmitted from the central apparatus 2B.

The central apparatus 2B (i) generates map information based on the extraction information provided by a mobile terminal 1B, (ii) evaluates completeness of the map information, (iii) generates command information based on the completeness, and (iv) selects, based on the command information and the estimation information transmitted from the mobile terminal 1B, command information and transmits the selected command information to the mobile terminal 1B that is the source of transmission. Hereinafter, the constituent elements of the mobile terminal 1B and the central apparatus 2B will be described in detail.

### Mobile Terminal 1B

The mobile terminal 1B includes extraction-information generation means 12B, instead of the extraction-information generation means 12 according to Embodiment 1. The extraction-information generation means 12B is a processing unit similar to the extraction-information generation means 12 according to Embodiment 1.

Specifically, the extraction-information generation means 12B is a processing unit that (i) associates and estimates feature types and feature regions from the measurement information acquired by the measurement-information acquisition means 11, (ii) generates provisional extraction information based on the measurement information, the feature types, and the feature regions and stores the generated provisional extraction information, (iii) generates estimation information that includes the positional information acquired by the positional-information acquisition means 10 and a list of feature types and transmits the generated estimation information to the central apparatus 2B, and (iv) selects extraction information from the stored provisional extraction information based on the command information transmitted from the central apparatus 2B to the mobile terminal 1B.

The extraction-information generation means 12B includes measurement-information extraction means 123B, provisional-extraction-information management means 124, and extraction-information selection means 125. Hereinafter, each constituent element of the extraction-information generation means 12B will be described in detail.

The measurement-information extraction means 123B is a processing unit that (i) associates and estimates feature types and feature regions from the measurement information, (ii) generates, as the provisional extraction information, partial measurement information by extraction from the measurement information on the feature region corresponding to each feature type, and (iii) generates estimation information that includes the positional information and the list of feature types that are included in the provisional extraction information and performs control to transmit the generated estimation information from the mobile terminal 1B to the central apparatus 2B. Note that the provisional extraction information according to Embodiment 2 of the present disclosure is similar to the extraction information (FIG. 7) according to Embodiment 1. Specifically, the provisional extraction information includes positional information that is used as the reference position in the measurement information, data that represents a subset of distance data extracted from the measurement information on the feature region, and feature types of features that are expressed by the above data and used in the extraction of the provisional extraction information.

The measurement-information extraction means 123B first combines multiple measurement information acquired by the measurement-information acquisition means 11. The combining method may be similar to the combining method used by the measurement-information extraction means 123 according to Embodiment 1. Note that in the case of using one measurement information, the measurement-information extraction means 123B may skip this combining processing.

Next, the measurement-information extraction means 123B applies feature estimation processing on the measurement information combined by the combining processing and thereby associates and estimates feature types and feature regions from the measurement information. The feature estimation processing method may be similar to the feature estimation processing method used by the measurement-information extraction means 123 according to Embodiment 1.

Then, for each of all the feature types acquired by the aforementioned estimation, the measurement-information extraction means 123B generates provisional extraction information by extraction from the measurement information on the feature region corresponding to the feature type. Then, the measurement-information extraction means 123B stores the generated provisional extraction information in the provisional-extraction-information management means 124.

Finally, the measurement-information extraction means 123B generates estimation information that includes the positional information and a list of the feature types included in the provisional extraction information, and transmits the generated estimation information to the central apparatus 2B via the mobile-terminal communication means 13.

The estimation information according to Embodiment 2 of the present disclosure is information that includes the positional information, which represents the reference position in the measurement information, and a list of the feature types estimated by the feature estimation processing, and is also information that does not include data such as distance data, unlike the extraction information. In addition to the positional information and the list of feature types, the estimation information may further include, for example, a generation time that represents the time when the estimation information is generated, or an identifier for uniquely identifying a mobile body that has generated the estimation information.

The provisional-extraction-information management means 124 is a database that manages the provisional extraction information by registering, storing, or deleting the provisional extraction information. The provisional extraction information managed by the provisional-extraction-information management means 124 is registered by the measurement-information extraction means 123B and referenced by the extraction-information selection means 125. Since the provisional extraction information according to Embodiment 2 of the present disclosure includes the positional information and the feature types, the provisional-extraction-information management means 124 also stores the positional information and the feature types by storing the provisional extraction information.

The extraction-information selection means 125 determines whether the positional information and each feature type that are included in the provisional extraction information stored in the provisional-extraction-information management means 124 correspond respectively to the target place and the target feature type that are included in the command information transmitted from the central apparatus 2B to the mobile terminal 1B. The extraction-information selection means 125 selects, based on the result of the determination, extraction information that is to be transmitted to the central apparatus 2B, from the provisional extraction information stored in the provisional-extraction-information management means 124 and transmits the selected extraction information to the central apparatus 2B via the mobile-terminal communication means 13.

In the method of selecting the extraction information, for example, when the positional information included in the provisional extraction information corresponds to the target place included in the command information and the feature type included in the provisional extraction information corresponds to the target feature type included in the command information, the extraction-information selection means 125 selects the provisional extraction information as the extraction information that is to be transmitted to the central apparatus 2B. The determination of the target place and the determination of the target feature type may be respectively similar to the determination performed by the command-information selection means 122 and the determination performed by the measurement-information extraction means 123 according to Embodiment 1.

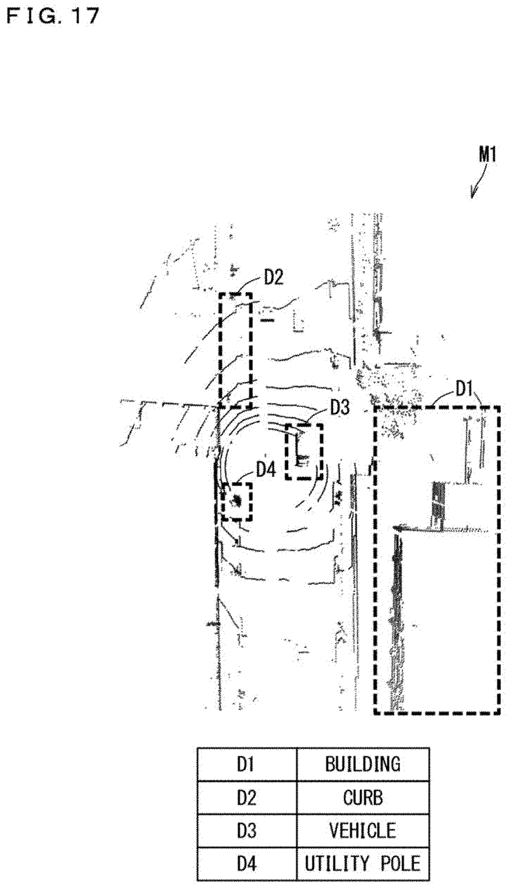

Next, one example of the operations of the measurement-information extraction means 123B will be described with reference to the drawings. FIGS. 16 to 18 are diagrams showing one example of the operations of the measurement-information extraction means 123B. The example illustrated in FIGS. 16 and 17 is similar to the example illustrated in FIGS. 4 and 5 according to Embodiment 1.

First, the measurement-information extraction means 123B acquires measurement information M1 as illustrated in FIG. 16, as in the case illustrated in FIG. 4. Next, as in the case illustrated in FIG. 5 according to Embodiment 1, the measurement-information extraction means 123B performs feature estimation processing on the measurement information M1 so as to obtain the result of estimation as illustrated in FIG. 17.

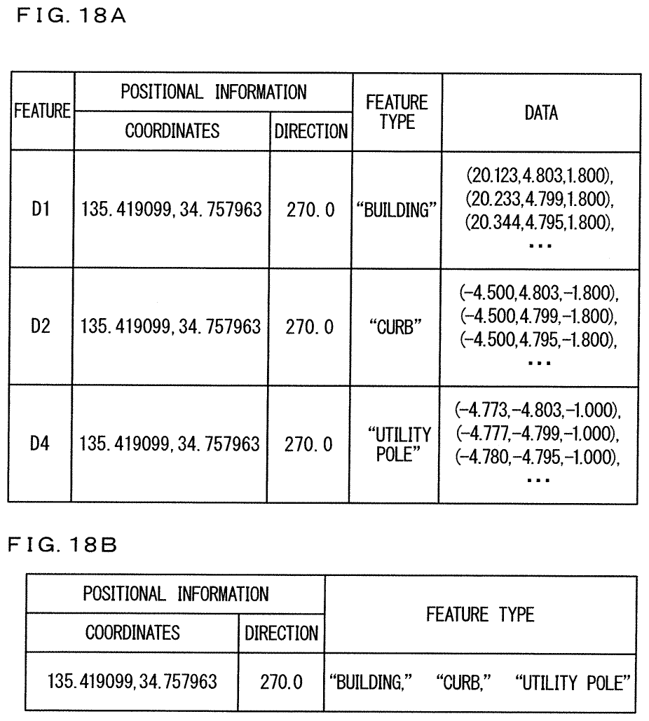

Then, the measurement-information extraction means 123B generates provisional extraction information on features D1 to D4. FIG. 18(a) is a diagram illustrating the generated provisional extraction information. As described above, the provisional extraction information includes positional information, feature types, and data extracted from the measurement information. As illustrated in FIG. 18(a), the measurement-information extraction means 123B does not necessarily have to generate provisional extraction information on the feature D3 that has a dynamic feature type of “vehicle” that is unnecessary in the generation of the map information.

Finally, the measurement-information extraction means 123B generates estimation information that includes the positional information and a list of the feature types included in the provisional extraction information. One example of generating estimation information that includes the positional information and a list of feature types of “building, “curb,” and “utility pole” that are included in the provisional extraction information is illustrated in FIG. 18(b).

The description will now return to the mobile terminal 1B illustrated in FIG. 15. The mobile-terminal communication means 13 of the mobile terminal 1B is a communicator that carries out information communication with the central apparatus 2B. The mobile-terminal communication means 13 not only carries out communication like the mobile-terminal communication means 13 according to Embodiment 1, but also transmits the estimation information generated by the extraction-information generation means 12B to the central apparatus 2B.

### Central Apparatus 2B

The central apparatus 2B includes map generation control means 22B, instead of the map generation control means 22 according to Embodiment 1. The map generation control means 22B (i) evaluates completeness of the map information, (ii) generates command information based on the completeness, (iii) stores the estimation information transmitted from the mobile terminal 1B to the central apparatus 2B, and (iv) based on the command information and the stored estimation information, selects command information and transmits the selected command information to the mobile terminal 1B that is the source of transmission.

As illustrated in FIG. 15, the configuration of the map generation control means 22B is similar to a configuration obtained by deleting the command-information management means 224, adding the estimation-information storage means 226, and replacing the transmit-command selection means 225 by the transmit-command selection means 225B in the configuration of the map generation control means 22 in FIG. 8 according to Embodiment 1.

The estimation-information storage means 226 is a database that manages the estimation information transmitted from the mobile terminal 1B to the central-apparatus communication means 20, by registering, referencing, or deleting the estimation information. The estimation-information storage means 226 associates and manages terminal identifiers and the estimation information.

The terminal identifiers as used herein refer to information that is used by the central apparatus 2B to uniquely identify each mobile terminal 1B, and the terminal identifiers may be information that allows the transmit-command selection means 225B to identify the mobile terminal 1B that transmits the command information. The terminal identifiers may, for example, be unique numbers assigned to the mobile terminals 1B, or may be communication addresses of the mobile terminals 1B.

The transmit-command selection means 225B is a processing unit that (i) determines whether the positional information and the list of feature types, both included in the estimation information stored in the estimation-information storage means 226, correspond respectively to the target place and the target feature type that are included in the command information generated by the command-information generation means 222, and (ii) selects, based on the result of the determination, command information that is to be transmitted from the central apparatus 2B to the mobile terminal 1B that is the source of transmission of the estimation information.

Specifically, the transmit-command selection means 225B first determines whether the positional information included in the estimation information stored in the estimation-information storage means 226 corresponds to the target place included in the command information generated by the command-information generation means 222. The determination as to whether the positional information corresponds to the target place may be similar to the determination made by the extraction-information selection means 125 according to Embodiment 2.

When it is determined that the positional information included in the estimation information corresponds to the target place included in the command information, the transmit-command selection means 225B determines which feature type in the list of feature types corresponds to the target feature type included in the command information.

When it is determined that any feature type in the list of feature types included in the estimation information corresponds to the target feature type included in the command information, the transmit-command selection means 225B identifies the terminal identifier of the mobile terminal 1B that has transmitted the estimation information. Then, the transmit-command selection means 2258 transmits the command information via the central-apparatus communication means 20 to the mobile terminal 1B that is identified by the terminal identifier and that is the source of transmission of the estimation information.

Note that, for example, the transmit-command selection means 225B may be configured to store the number of times the command information is transmitted from the central apparatus 2B to each mobile terminal 1B and not to transmit the command information when the above number exceeds a preset threshold value. Alternatively, for example, the transmit-command selection means 225B may be configured to store total data volume of the extraction information that can be transmitted from each mobile terminal 1B to the central apparatus 2B and not to transmit the command information when the total data volume exceeds a preset threshold value.

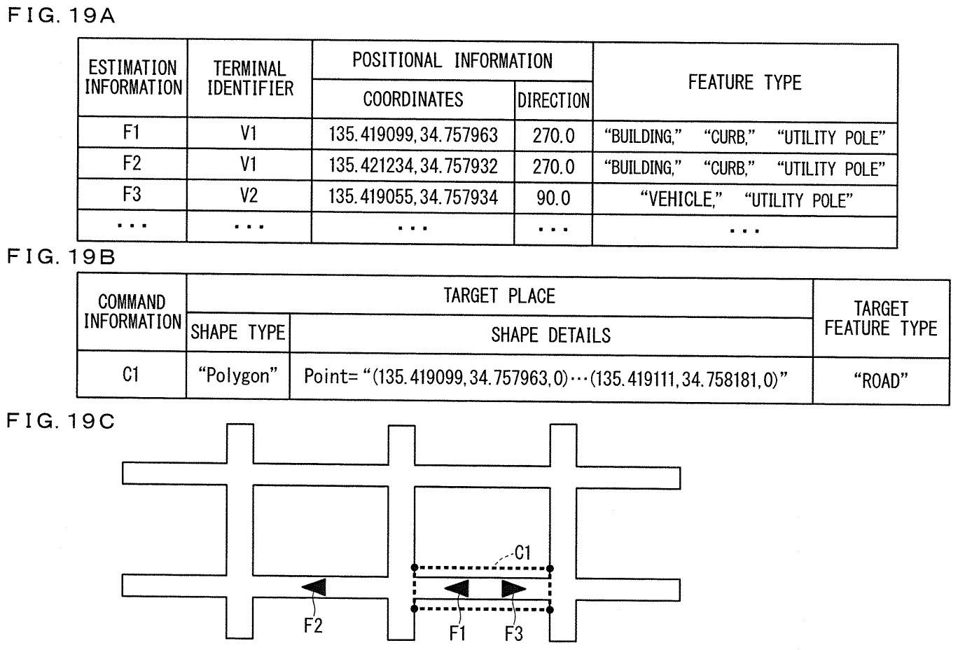

Next, one example of the operations of the transmit-command selection means 225B will be described with reference to the drawings. FIG. 19 is a diagram showing one example of the operations of the transmit-command selection means 225B. FIG. 19(a) is a diagram illustrating a combination of the terminal identifiers stored in the estimation-information storage means 226 and estimation information F1 to F3 (the positional information and a list of feature types). FIG. 19(b) illustrates command information C1 generated by the command-information generation means 222. FIG. 19(c) is a diagram illustrating a positional relation between the estimation information F1 to F3 (positional information) and the position of the target place included in the command information C1. In FIG. 19(c), the broken line indicating the command information C1 represents the target place and indicates that the estimation information F1 and F3 exist in the target place included in the command information C1. In the example illustrated in FIG. 19, the feature type of “curb” is assumed to correspond to the target feature type of “road.”

First, the transmit-command selection means 225B determines whether the estimation information F1 corresponds to the command information C1. That is, the transmit-command selection means 225B compares the positional information included in the estimation information F1 with the target place included in the command information C1 and compares the feature type included in the estimation information F1 with the target feature type included in the command information C1. Since, in the example illustrated in FIG. 19, the estimation information F1 exists in the target place included in the command information C1 and the feature type of “curb” corresponds to the target feature type of “road,” the transmit-command selection means 225B determines that the estimation information F1 corresponds to the command information C1. Thus, the transmit-command selection means 225B selects a terminal identifier of “V1” as the destination of transmission of the command information C1.

Next, the transmit-command selection means 225B determines, as in the case of the estimation information F1, whether the estimation information F2 corresponds to the command information C1. The feature type of “curb” corresponds to the target feature type of “road,” but the estimation information F2 does not exist in the target place included in the command information C1. Thus, the transmit-command selection means 225B determines that the estimation information F2 does not correspond to the command information C1.

Then, the transmit-command selection means 225B determines, as in the case of the estimation information F1 and F2, whether the estimation information F3 corresponds to the command information C1. The estimation information F3 exists in the target place included in the command information C1, but there is no feature type that corresponds to the target feature type of “road.” Thus, the transmit-command selection means 225B determines that the estimation information F3 does not correspond to the command information C1.

Finally, the transmit-command selection means 225B transmits the command information C1 to the mobile terminal 1B identified by the terminal identifier of “V1.”

### Summary of Embodiment 2

According to Embodiment 2 of the present disclosure as described above, in cases such as where the processing allows some leeway, the extraction-information generation means 12B of each mobile terminal 1B generates the provisional extraction information, irrespective of the presence or absence of the command information, and transmits the estimation information that includes the positional information and a list of feature types to the central apparatus 2B. The map generation control means 22B of the central apparatus 2B selects the destination of transmission of the command information based on the positional information and the feature types that are both included in the estimation information. Accordingly, when the central apparatus 2B transmits the command information, the provisional extraction information serving as a candidate for the extraction information has already been generated by a mobile terminal 1B. This allows the central apparatus 2B to quickly collect the extraction information.

### Embodiment 3

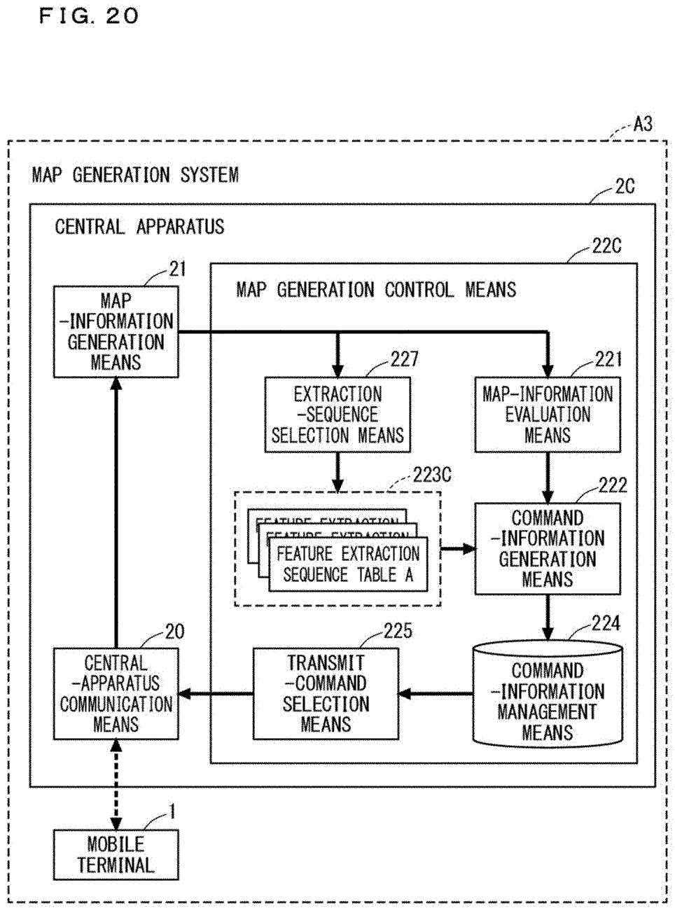

Embodiment 3 of the present disclosure will be described with reference to the drawings. FIG. 20 is a block diagram illustrating a functional configuration of a map generation system A3 according to Embodiment 3 of the present disclosure. Note that the basic configuration of the map generation system A3 according to Embodiment 3 of the present disclosure is similar to the configuration of the map generation system A1 according to Embodiment 1, and therefore the following description mainly focuses on points of difference.

The points of difference between the map generation system A1 according to Embodiment 1 and the map generation system A3 according to Embodiment 3 of the present disclosure are as follows. The map generation system A1 according to Embodiment 1 generates command information based on one feature extraction sequence table. On the other hand, the map generation system A3 according to Embodiment 3 of the present disclosure includes a plurality of feature extraction sequence tables and changes, based on the map information, the feature extraction sequence table that is used in the generation of the command information.

The map generation system A3 includes a central apparatus 2C, instead of the central apparatus 2 of the map generation system A1 according to Embodiment 1. The central apparatus 2C not only has the function of the central apparatus 2 according to Embodiment 1, but also changes, based on the map information, the feature extraction sequence table that is used in the generation of the command information among the plurality of feature extraction sequence tables.

The central apparatus 2C includes map generation control means 22C, instead of the map generation control means 22 according to Embodiment 1. The map generation control means 22C not only has the function of the map generation control means 22 according to Embodiment 1, but also changes, based on the map information in preparation, the feature extraction sequence table that is used to generate the command information among the plurality of feature extraction sequence tables.

The configuration of the map generation control means 22C is similar to a configuration obtained by changing one feature extraction sequence table 223 into a plurality of feature extraction sequence tables 223C and adding the extraction-sequence selection means 227 in the configuration of the map generation control means 22 according to Embodiment 1. The extraction-sequence selection means 227 selects a feature extraction sequence table that is used to generate command information from among the plurality of feature extraction sequence tables based on the map information in preparation. Hereinafter, each constituent element of the map generation control means 22C will be described in detail.

The feature extraction sequence tables 223C are each similar to the feature extraction sequence table 223 according to Embodiment 1, but differ from each other in the target feature type corresponding to each completeness.

The plurality of feature extraction sequence tables 223C are respectively associated in advance with a plurality of space types, and each space type represents the type of space to be mapped, i.e., a class to which the target space belongs.

The space types are attribute values obtained by classifying each portion of the target space by similar spaces, and the number of feature extraction sequence tables is prepared advance to the same number as the number of space types. In the case of road map information, for example, the space types may include highway, trunk road, and service road for daily living. In the case of indoor map information, for example, the space types may include room, entrance hall, and passage.

In a map generation system for generating road map information, for example, the feature extraction sequence tables 223C may include a feature extraction sequence table for highways, a feature extraction sequence table for trunk roads, and a feature extraction sequence table for service roads for daily living. In a map generation system for generating indoor map information, for example, the feature extraction sequence tables 223C may include a feature extraction sequence table for rooms, a feature extraction sequence table for entrance halls, and a feature extraction sequence table for open passages. In a seamless map generation system of either indoor or outdoor type, for example, the feature extraction sequence tables 223C may include all of the above feature extraction sequence tables.

The extraction-sequence selection means 227 is a processing unit that (i) estimates a space type based on the map information generated by the map-information generation means 21, and (ii) switches the feature extraction sequence table by selecting a feature extraction sequence table 223C that corresponds to the estimated space type from among the plurality of feature extraction sequence tables 223C as the feature extraction sequence table that is used by the command-information generation means 222. The extraction-sequence selection means 227 cuts the entire or part of the range indicated by the map information and selects a feature extraction sequence table that is applied to the cut range.

Alternately, for example, the extraction-sequence selection means 227 may estimate a space type by determining whether, in the map information generated by the map-information generation means 21, the width or crossover spacing of a feature that represents the range of travel of a mobile body is included in a threshold range that is set in advance for each space type. As another alternative, for example, the extraction-sequence selection means 227 may estimate a space type by determining whether, in the map information generated by the map-information generation means 21, the spacing of a feature that limits the travel of a mobile body is included in a threshold range that is set in advance for each space type. As yet another alternative, in the case where map information that includes a space type for each position is prepared in advance, for example, the extraction-sequence selection means 227 may estimate a space type based on the position of a feature included in the map information generated by the map-information generation means 21.

Note that, in the case where the space type is not appropriately estimated, the extraction-sequence selection means 227 may use a preset standard feature extraction sequence table as the result of estimation. The map-information evaluation means 221 may further evaluate the completeness of the map information for each range that is cut by the extraction-sequence selection means 227.

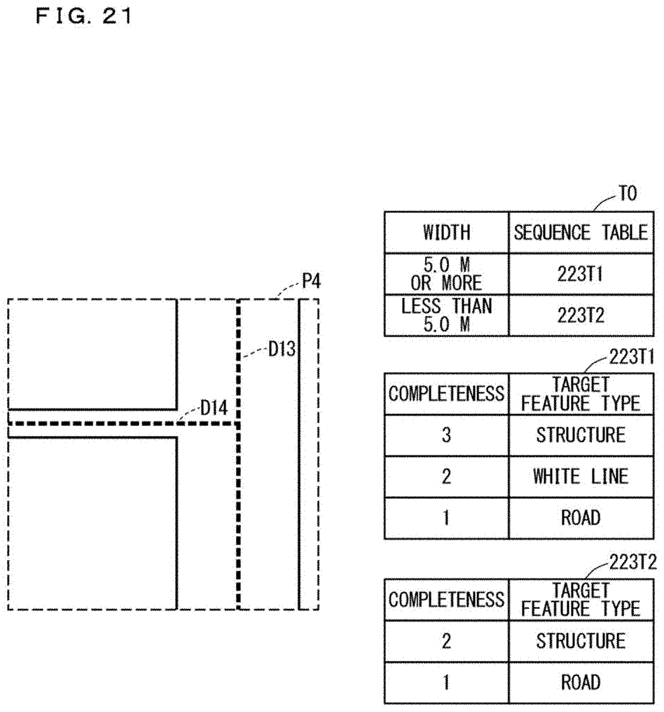

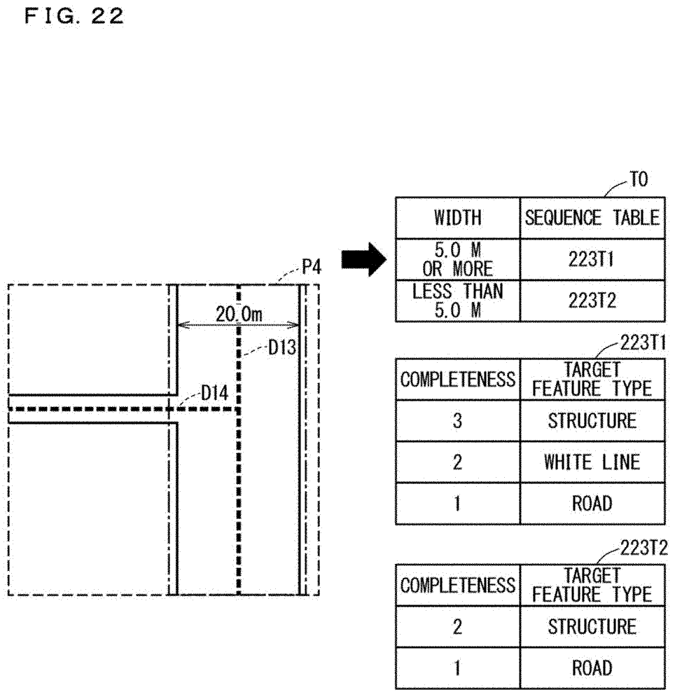

Next, one example of the operations of the extraction-sequence selection means 227 will be described with reference to the drawings. FIGS. 21 to 23 are diagrams showing one example of the operations of the extraction-sequence selection means 227. Here, the central apparatus 2C is assumed to generate road map information as the map information. In the example illustrated in FIGS. 21 to 23, a case is assumed in which the extraction-sequence selection means 227 switches among the feature extraction sequence tables 223C according to a table T0 and based on a space type estimated from the width of a road and a threshold value for the width. Here, a case is also assumed in which the feature extraction sequence tables 223C include a feature extraction sequence table 223T1 for trunk roads and a feature extraction sequence table 223T2 for service roads for daily living.

FIG. 21 is a diagram illustrating an input state of the extraction-sequence selection means 227. FIG. 21 illustrates map information P4 that includes features D13 and D14, the table T0 that shows the correspondence between the threshold value for the width of each road and the feature extraction sequence tables 223T1 and 223T2, and the feature extraction sequence tables 223T1 and 223T2. The features D13 and D14 are road-related features, and in the map information P4, the solid lines indicate road shoulder edges, and the broken lines indicate road center lines.

FIG. 22 illustrates a state when the extraction-sequence selection means 227 switches the feature extraction sequence table for the surroundings of the feature D13. In FIG. 22, since the feature D13 has a width of “20.0 m,” the extraction-sequence selection means 227 selects, for a region indicated by the dashed dotted lines around the feature D13, the feature extraction sequence table 223T1 from the table T0 as a feature extraction sequence table that is used by the command-information generation means 222.

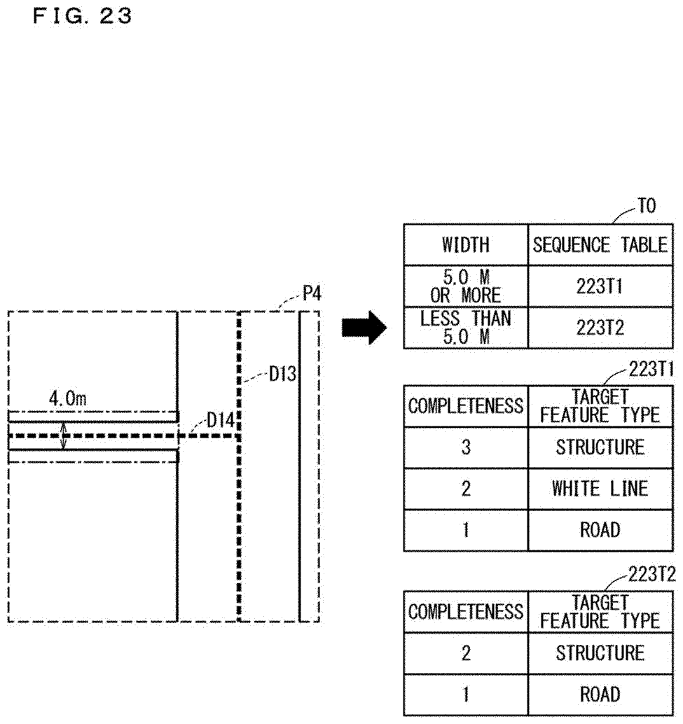

FIG. 23 illustrates a state when the extraction-sequence selection means 227 switches the feature extraction sequence table for the surroundings of the feature D14. In FIG. 23, since the feature D14 has a width of “4.0 m,” the extraction-sequence selection means 227 selects, for a region illustrated by the dashed dotted lines around the feature D14, the feature extraction sequence table 223T2 from the table T0 as a feature extraction sequence table that is used by the command-information generation means 222.

### Summary of Embodiment 3

According to Embodiment 3 of the present disclosure as described above, the extraction-sequence selection means 227 estimates a space type based on the map information and switches, based on the estimated space type, the feature extraction sequence table that is used by the command-information generation means 222. This allows the map generation system A3 to switch the order of features that are collected according to the space type of the target space and to reduce unnecessary communication of information. Accordingly, it is possible to appropriately reduce communication data volume.

### Embodiment 4

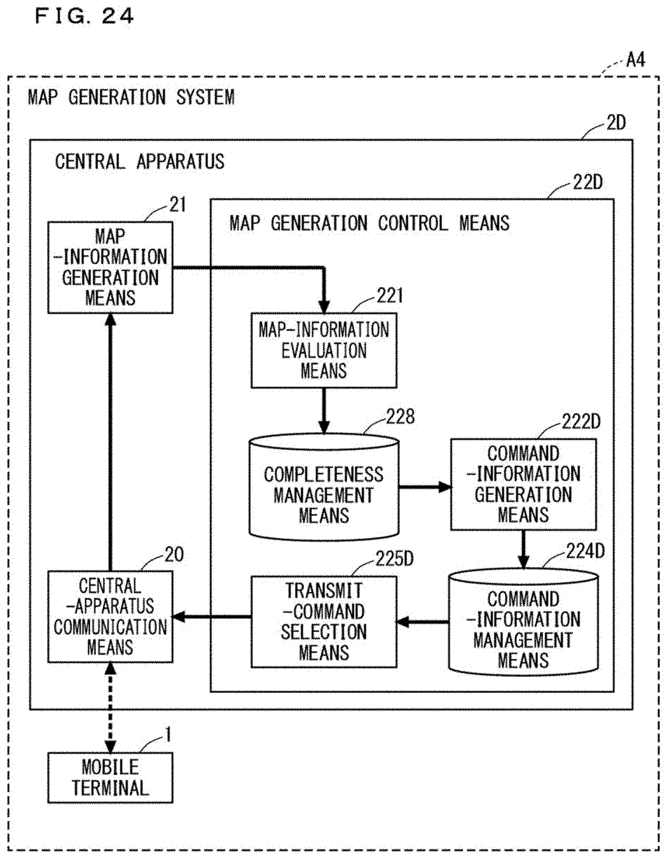

Embodiment 4 of the present disclosure will be described with reference to the drawings. FIG. 24 is a block diagram illustrating a functional configuration of a map generation system A4 according to Embodiment 4 of the present disclosure. Note that the basic configuration of the map generation system A4 according to Embodiment 4 of the present disclosure is similar to the configuration of the map generation system A1 according to Embodiment 1, and therefore the following description omits the same points and focuses on only the points of difference.

The points of difference between the map generation system A1 according to Embodiment 1 and the map generation system A4 according to Embodiment 4 of the present disclosure are as follows. The map generation system A1 according to Embodiment 1 generates command information by designating the target feature type in the order of completeness according to the feature extraction sequence table. On the other hand, the map generation system A4 according to Embodiment 4 of the present disclosure generates the ratio of acquisition for each target feature type. Note that the ratio of acquisition refers to the ratio of each target feature type to be extracted by a mobile terminal 1 and may correspond to, for example, the priority of extraction as will be described later.

The map generation system A4 includes a central apparatus 2D, instead of the central apparatus 2 of the map generation system A1 according to Embodiment 1. The central apparatus 2D not only has the function of the central apparatus 2 according to Embodiment 1, but also associates and generates the ratios of acquisition and the command information based on the completeness for each target feature type and selects, based on the ratio of acquisition, command information that is to be transmitted from the central apparatus 2D to the mobile terminal 1.

The central apparatus 2D includes map generation control means 22D, instated of the map generation control means 22 according to Embodiment 1. The map generation control means 22D not only has the function of the map generation control means 22 according to Embodiment 1, but also (i) evaluates the completeness of the map information for each target feature type, (ii) associates and generates the ratios of acquisition and the command information based on the completeness for each target feature type, and (iii) selects command information that is to be transmitted from the central apparatus 2D to the mobile terminal 1, based on the positional information transmitted from a mobile terminal 1 to the central apparatus 2D, the ratio of acquisition, and the target place included in the command information.

The configuration of the map generation control means 22D is similar to a configuration obtained by deleting the feature extraction sequence table 223, adding completeness management means 228 that manages (stores) the completeness for each target feature type, and replacing the command-information generation means 222, the command-information management means 224, and the transmit-command selection means 225 by command-information generation means 222D, command-information management means 224D, and transmit-command selection means 225D in the configuration of the map generation control means 22 according to Embodiment 1.

The command-information generation means 222D associates and generates the ratios of acquisition and the command information based on the completeness for each target feature type stored in the completeness management means 228. The command-information management means 224D manages (stores) the ratios of acquisition and the command information generated by the command-information generation means 222D. The transmit-command selection means 225D selects command information that is to be transmitted from the central apparatus 2D to the mobile terminal 1 from the command-information management means 224D based on the positional information transmitted from the mobile terminal 1 to the central apparatus 2D, the ratio of acquisition, and the target place included in the command information. Hereinafter, the constituent elements of the map generation control means 22D will be described in detail.

The completeness management means 228 is a database that manages the completeness for each target feature type by registering, updating, storing, or deleting the completeness for each target feature type, the completeness being evaluated (calculated) by the map-information evaluation means 221 for the map information generated by the map-information generation means 21. The completeness management means 228 associates the target feature types, the completeness of the map information for each target feature type, and the regions to be evaluated with one another for the map information evaluated by the map-information evaluation means 221, and stores the resultant information as completeness information. The completeness management means 228 provides this completeness information to the command-information generation means 222D.

The command-information generation means 222D is a processing unit that (i) calculates the ratio of features to be extracted by the mobile terminal 1 for each target feature type based on the completeness information managed by the completeness management means 228, and generates the command information, and (ii) causes the command-information management means 224D to manage the ratios of acquisition that is the result of calculation and the command information.

Specifically, the command-information generation means 222D first acquires completeness information on the same sections from the completeness information managed by the completeness management means 228. Next, the command-information generation means 222D compares the completeness for each target feature type based on the completeness information so as to set the ratio of acquisition that represents, for each target feature type, the ratio of priority extraction of the extraction information by a mobile terminal 1. At this time, the command-information generation means 222D may set the ratios of acquisition such that a higher ratio of acquisition is set for the target feature type with lower completeness or such that, in consideration of the priority of each target feature type, a higher ratio of acquisition is set for a target feature type with higher priority. The command-information generation means 222D associates and generates the command information and the ratios of acquisition from the completeness information. Finally, the command-information generation means 222D registers the ratios of acquisition and the command information in the command-information management means 224D.

The command information generated and managed by the central apparatus 2D includes a target place and a plurality of target feature types. The command information may be generated by the command-information generation means 222D, managed by the command-information management means 224D, or may be processed by the transmit-command selection means 225D into command information that is to be transmitted to a mobile terminal 1.

The command-information management means 224D is a database that manages the ratios of acquisition and the command information by registering, storing, or deleting one or more ratios of acquisition and one or more command information generated by the command-information generation means 222D, and provides the ratio of acquisition and the command information in response to a request from the transmit-command selection means 225D.

The transmit-command selection means 225D is a processing unit that (i) predicts the accessible range of a mobile terminal 1 in the same manner as the transmit-command selection means 225 according to Embodiment 1, and (ii) selects (determines) command information that is to be transmitted from the central apparatus 2D to the mobile terminal 1 from the command-information management means 224D based on the accessible range, the ratio of acquisition, and the target place included in the command information.

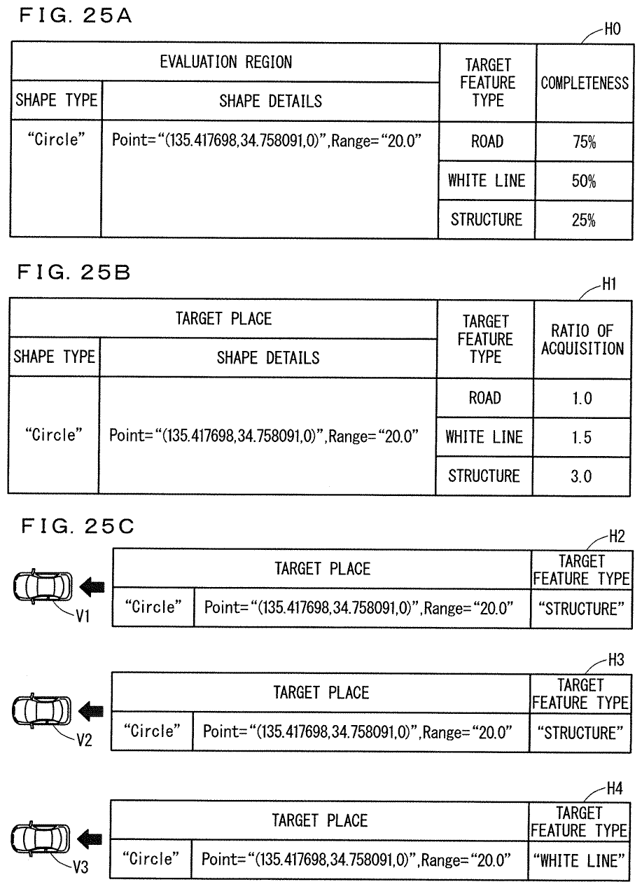

Next, one example of the operations of the map generation control means 22D will be described with reference to the drawings. FIG. 25 is a diagram showing one example of the operations of the map generation control means 22D. Here, a case is assumed in which the map generation system A4 generates road map information and there are three target feature type including “road,” “white line,” and “structure.”

FIG. 25(a) is a diagram illustrating completeness information H0 that is evaluated by the map-information evaluation means 221 and managed by the completeness management means 228. The completeness information H0 indicates that the completeness for the target feature type of “road” is “75%,” the completeness for the target feature type of “white line” is “50%,” and the completeness for the target feature type of “structure” is “25%.”

FIG. 25(b) is a diagram illustrating information H1 that is generated by the command-information generation means 222D and combines the ratios of acquisition and the command information managed by the command-information management means 224D. This information H1 indicates the ratios of acquisition for different target feature types when the ratio of acquisition for the target feature type of “road” is “1.0.” In this example, the command-information generation means 222D determines the ratios of acquisition based on the ratio of the reciprocal of the completeness illustrated in FIG. 25(a).

FIG. 25(c) is a diagram illustrating command information H2 to H4 that are selected by the transmit-command selection means 225D and transmitted from the central apparatus 2D, and mobile bodies V1 to V3 that are the destinations of transmission of the command information H2 to H4, respectively. The command information H2 to H4 include the same target place, and the accessible ranges of the mobile bodies V1 to V3 correspond to this target place.

The transmit-command selection means 225D sets the target feature type to be extracted by a mobile terminal 1, based on the ratios of acquisition illustrated in FIG. 25(b). In this example, the transmit-command selection means 225D makes the number of mobile terminals 1 for which the target feature type with a high ratio of acquisition is set, larger than the number of mobile terminals 1 for which the target feature type with a low ratio of acquisition is set. As a result, as illustrated in FIG. 25(c), the transmit-command selection means 225D sets the target feature type of “structure” for the mobile bodies V1 and V2 and sets the target feature type of “white line” for the mobile body V3. Accordingly, the command information H2 and H3 for extracting the target feature type of “structure” are transmitted respectively to the mobile terminals 1 of the mobile bodies V1 and V2, and the command information H4 for extracting the target feature type of “white line” is transmitted to the mobile terminal 1 of the mobile body V3.

### Summary of Embodiment 4

According to Embodiment 4 of the present disclosure as described above, the map generation control means 22D determines, based on the completeness of the map information for each target feature type, the ratio of acquisition that is the ratio of the target feature type to be extracted by the mobile terminal and selects command information that is to be transmitted to the mobile terminal, based on the ratio of acquisition. This allows the map generation system A4 to generate the command information that includes a plurality of target feature types with the same timing while appropriately reducing communication data volume.

### Other Variations

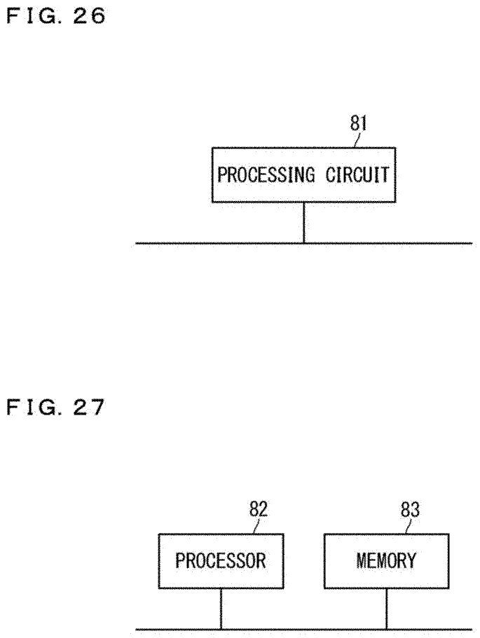

The map-information generation means 21 and the map generation control means 22 illustrated in FIG. 8 described above are hereinafter referred to as the “map-information generation means 21 and so on.” The map-information generation means 21 and so on are achieved by a processing circuit 81 of the central apparatus 2 illustrated in FIG. 26. That is, the processing circuit 81 of the central apparatus 2 includes the map-information generation means 21 that generates the map information based on the extraction information transmitted from the mobile terminal 1 to the central apparatus 2, and the map generation control means 22 that evaluates the completeness of the map information generated by the map-information generation means 21 and generates the command information based on the completeness. Dedicated hardware may be applied to the processing circuit 81, or a processor that executes programs stored in a memory may be applied to the processing circuit 81. Examples of the processor include a central processing unit, a processing unit, an arithmetic-logic unit, a microprocessor, a microcomputer, and a digital signal processor (DSP).

In the case where dedicated hardware is applied to the processing circuit 81, for example, the processing circuit 81 may correspond to a single circuit, a composite circuit, a programmed processor, a parallel programmed processor, an application specific integrated circuit (ASIC), or a field programmable gate array (FPGA), or may be any combination of the above. The function of each constituent element of the map-information generation means 21 and so on may be achieved as a circuit that includes distributed processing circuits, or may be achieved as one processing circuit that collectively has the functions of the constituent elements.

In the case where a processor is applied to the processing circuit 81, the functions of the map-information generation means 21 and so on may be implemented by combining with software and so on. For example, the software and so on correspond to software, firmware, or a combination of software and firmware. The software and so on are described as programs and stored in the memory. As illustrated in FIG. 27, a processor 82 applied to the processing circuit 81 achieves the function of each constituent element by reading and executing programs stored in a memory 83. That is, when the function of each constituent element is executed by the processing circuit 81, the central apparatus 2 includes the memory 83 for storing a program that results in the execution of the step of generating map information based on the extraction information transmitted from the mobile terminal 1 to the central apparatus 2 and the step of evaluating the completeness of the generated map information and generating the command information based on the completeness. In other words, it can also be said that this program causes a computer to execute the procedure or method used in the map-information generation means 21 and so on. The memory 83 as used herein may, for example, be a nonvolatile or volatile semiconductor memory such as a random access memory (RAM), a read only memory (ROM), a flash memory, an erasable programmable read only memory (EPROM), or an electrically erasable programmable read only memory (EEPROM), or a drive unit and so on for driving the above memory, such as a hard disk drive (HDD), a magnetic disk, a flexible disk, an optical disk, a compact disk, a minidisk, or a digital versatile disc (DVD), or may be any other recording medium that may be used in the future.

The above has been a description of the configuration in which the function of each constituent element such as the map-information generation means 21 and so on is achieved by any of hardware and software and so on. The present disclosure is, however, not limited to the examples described above, and a configuration is also possible in which some of the constituent elements such as the map-information generation means 21 and so are realized as dedicated hardware, and other some of the constituent elements are realized as software and so on. For example, the function of the map-information generation means 21 may be achieved by the processing circuit 81 and the interface and so on that serve as dedicated hardware, and the functions of the other constituent elements may be achieved by the processing circuit 81, which serves as the processor 82, reading and executing programs stored in the memory 83.

As described above, the processing circuit 81 can achieve each of the functions described above by hardware or software and so on or by any combination of the above. Although the above has been a description of the map-information generation means 21 and the map generation control means 22 of the central apparatus 2, the same applies to the positional-information acquisition means 10, the measurement-information acquisition means 11, and the extraction-information generation means 12 of the mobile terminals 1. The constituent elements of the map information generation system described above may be distributed and arranged in either of the mobile terminal 1 and the central apparatus 2, or may be centrally arranged in any equipment.

It should be noted that the present disclosure can be implemented by freely combining the above embodiments or by making a modification or omission to the embodiments as appropriate without departing from the scope of the present disclosure.

While the invention has been shown and described in detail, the foregoing description is in all aspects illustrative and not restrictive. It is therefore to be understood that numerous modifications and variations can be devised without departing from the scope of the invention.

### EXPLANATION OF REFERENCE SIGNS

1, 1B mobile terminal

2, 2B, 2C, 2D central apparatus

10 positional-information acquisition means

11 measurement-information acquisition means

12, 12B extraction-information generation means

21 map-information generation means

22, 22B, 22C, 22D map generation control means

121 command-information storage means

122 command-information selection means

123, 123B measurement-information extraction means

124 provisional-extraction-information management means

125 extraction-information selection means

211 estimation-method selection means

212 feature estimation means

221 map-information evaluation means

222, 222D command-information generation means

223, 223C feature extraction sequence table

224, 224D command-information management means

225, 225B, 225D transmit-command selection means

226 estimation-information storage means

227 extraction-sequence selection means

228 completeness management means

A1, A2, A3, A4 map generation system

V1 to V3 mobile body

1. A central apparatus for communicating with a mobile terminal that is movable with a mobile body,
the mobile terminal including:
positional-information acquisition circuitry that acquires positional information on the mobile body;
measurement-information acquisition circuitry that acquires measurement information by measuring a space around the mobile body as a space to be mapped; and
extraction-information generation circuitry that generates extraction information by extraction from the measurement information based on the positional information and command information transmitted from the central apparatus to the mobile terminal,
the central apparatus comprising:
map-information generation circuitry that generates map information based on the extraction information transmitted from the mobile terminal to the central apparatus; and
map generation control circuitry that evaluates completeness on a type and positional accuracy of a feature in the map information generated by the map-information generation circuitry and generates the command information based on the completeness.

2. The central apparatus according to claim 1, wherein
the command information includes:
a target place that represents a place to be extracted; and
a target feature type that represents a type of a feature to be extracted, and
the map generation control circuitry of the central apparatus switches the target feature type included in the command information based on the completeness; and
the extraction-information generation circuitry of the mobile terminal associates and estimates a feature type and a feature region from the measurement information, the feature type representing a type of a feature, the feature region representing a region of the feature, and generates the extraction information on the feature region corresponding to the feature type by extraction from the measurement information based on a result of determination as to whether the positional information and the feature type correspond respectively to the target place and the target feature type that are included in the command information.

3. The central apparatus according to claim 2, wherein
the map generation control circuitry of the central apparatus includes:
map-information evaluation circuitry that evaluates the completeness of the map information;
a feature extraction sequence table that represents a correspondence between the completeness and the target feature type;
command-information generation circuitry that generates, based on the completeness evaluated by the map-information evaluation circuitry, the command information that includes the target feature type corresponding to the completeness according to the feature extraction sequence table;
command-information management circuitry that stores the command information generated by the command-information generation circuitry; and
transmit-command selection circuitry that predicts, based on the positional information transmitted from the mobile terminal to the central apparatus, an accessible range that represents a range that the mobile terminal can reach, and selects the command information that is to be transmitted from the central apparatus to the mobile terminal, from the command-information management circuitry based on the accessible range and the target place included in the command information.

4. The central apparatus according to claim 2, wherein the extraction-information generation circuitry of the mobile terminal includes:
command-information storage circuitry that stores the command information transmitted from to the central apparatus to the mobile terminal;
command-information selection circuitry that selects the command information from the command-information storage circuitry based on a result of determination as to whether the positional information corresponds to the target place included in the command information stored in the command-information storage circuitry; and
measurement-information extraction circuitry that associates and estimates the feature type and the feature region from the measurement information and generates the extraction information on the feature region corresponding to the feature type by extraction from the measurement information based on a result of determination as to whether the feature type corresponds to the target feature type included in the command information selected by the command-information selection circuitry.

5. The central apparatus according to claim 2, wherein
the extraction-information generation circuitry of the mobile terminal includes:
measurement-information extraction circuitry that associates and estimates the feature type and the feature region from the measurement information and generates provisional extraction information that is information extracted for each of the feature types from the measurement information on the feature region and that includes the feature type used in the extraction;
provisional-extraction-information management circuitry that stores the positional information and the provisional extraction information; and
extraction-information selection circuitry that selects the extraction information from the provisional extraction information stored in the provisional-extraction-information management circuitry based on a result of determination as to whether the positional information and the feature type included in the provisional extraction information stored in the provisional-extraction-information management circuitry correspond respectively to the target place and the target feature type that are included in the command information transmitted from the central apparatus to the mobile terminal.

6. The central apparatus according to claim 5, wherein
the measurement-information extraction circuitry of the mobile terminal generates estimation information that includes the positional information and a list of the feature type included in the provisional extraction information,
the map generation control circuitry of the central apparatus includes:
map-information evaluation circuitry that evaluates the completeness of the map information;
a feature extraction sequence table that represents a correspondence between the completeness and the target feature type;
command-information generation circuitry that generates, based on the completeness evaluated by the map-information evaluation circuitry, the command information that includes the target feature type corresponding to the completeness according to the feature extraction sequence table;
estimation-information storage circuitry that stores the estimation information transmitted from the mobile terminal to the central apparatus; and
transmit-command selection circuitry that selects the command information that is to be transmitted from the central apparatus to the mobile terminal that is a source of transmission of the estimation information, based on a result of determination as to whether the positional information and the list of the feature type that are included in the estimation information correspond respectively to the target place and the target feature type that are included in the command information generated by the command-information generation circuitry.

7. The central apparatus according to claim 3, wherein
a plurality of feature extraction sequence tables, each being the feature extraction table, are associated with a plurality of space types each representing a type of the space to be mapped,
the map generation control circuitry of the central apparatus further includes:
extraction-sequence selection circuitry that estimates the space type based on the map information generated by the map-information generation circuitry and selects, from among the plurality of feature extraction sequence tables, a feature extraction sequence table that corresponds to the space type as the feature extraction sequence table that is used by the command-information generation circuitry.

8. The central apparatus according to claim 2, wherein
the extraction information includes the feature type corresponding to the target feature type,
the map-information generation circuitry of the central apparatus includes:
estimation-method selection circuitry that selects, from among a plurality of feature estimation methods, a feature estimation method that corresponds to the feature type included in the extraction information transmitted from the mobile terminal to the central apparatus; and
feature estimation circuitry that estimates a position or shape of a feature, using the feature estimation method selected by the estimation-method selection circuitry.

9. The central apparatus according to claim 3, wherein
the map-information evaluation circuitry of the central apparatus evaluates reliability of positional accuracy of a feature in an evaluation range that is included in a range indicated by the map information, and calculates the completeness based on a result of evaluation of the reliability, and
the command-information generation circuitry of the central apparatus generates the command information that includes an entire or part of the evaluation range as the target place.

10. The central apparatus according to claim 2, wherein
the map generation control circuitry of the central apparatus includes:
map-information evaluation circuitry that evaluates the completeness of the map information for each of the target feature types;
completeness management circuitry that stores the completeness for each of the target feature types;
command-information generation circuitry that associates and generates a ratio of acquisition and the command information based on the completeness for each of the target feature types stored in the completeness management circuitry, the ratio of acquisition being a ratio of the target feature type to be extracted by the mobile terminal;
command-information management circuitry that stores the ratio of acquisition and the command information that are generated by the command-information generation circuitry; and
transmit-command selection circuitry that predicts, based on the positional information transmitted from the mobile terminal to the central apparatus, an accessible range that the mobile terminal can reach, and selects the command information that is to be transmitted from the central apparatus to the mobile terminal, from the command-information management circuitry based on the accessible range, the ratio of acquisition, and the target place included in the command information.

11. A map generation system comprising:
the central apparatus according to claim 1; and
the mobile terminal.

12. A map generation method for use in a central apparatus that communicates with a mobile terminal that is movable with a mobile body, the map generation method comprising:
causing the mobile terminal to:
acquire positional information on the mobile body;
acquire measurement information by measuring a space around the mobile body as a space to be mapped; and
generate extraction information by extraction from the measurement information based on the positional information and command information transmitted from the central apparatus to the mobile terminal,
causing the central apparatus to:
generate map information based on the extraction information transmitted from the mobile terminal to the central apparatus; and
evaluate completeness on a type and positional accuracy of a feature in the map information generated and generate the command information based on the completeness.

13. A central apparatus for communicating with a mobile terminal that is movable with a mobile body,
the mobile terminal including:
positional-information acquisition circuitry that acquires positional information on the mobile body;
measurement-information acquisition circuitry that acquires measurement information by measuring a space around the mobile body as a space to be mapped; and
extraction-information generation circuitry that associates and estimates a feature type and a feature region from the measurement information based on the positional information and command information transmitted from the central apparatus to the mobile terminal, the feature type representing a type of a feature, the feature region representing a region of the feature, the command information including: a target place that represents a place to be extracted; and a target feature type that represents a type of a feature to be extracted, and generates extraction information on the feature region corresponding to the feature type by extraction from the measurement information based on a result of determination as to whether the positional information and the feature type correspond respectively to the target place and the target feature type that are included in the command information,
the central apparatus comprising:
map-information generation circuitry that generates map information based on the extraction information transmitted from the mobile terminal to the central apparatus; and
map generation control circuitry that evaluates completeness of the map information generated by the map-information generation circuitry, and generates the command information and switches the target feature type included in the command information, based on the completeness,
the map generation control circuitry of the central apparatus includes:
map-information evaluation circuitry that evaluates the completeness of the map information;
a feature extraction sequence table that represents a correspondence between the completeness and the target feature type;
command-information generation circuitry that generates, based on the completeness evaluated by the map-information evaluation circuitry, the command information that includes the target feature type corresponding to the completeness according to the feature extraction sequence table;
command-information management circuitry that stores the command information generated by the command-information generation circuitry; and
transmit-command selection circuitry that predicts, based on the positional information transmitted from the mobile terminal to the central apparatus, an accessible range that represents a range that the mobile terminal can reach, and selects the command information that is to be transmitted from the central apparatus to the mobile terminal, from the command-information management circuitry based on the accessible range and the target place included in the command information.
